(19) United States
(12) Patent Application Publication
(10) Pub. No.: US 2025/0026058 A1
(43) Pub. Date: Jan. 23, 2025

(54) INJECTION MOLDING METHOD, MOLDING CONDITION DERIVATION DEVICE, AND COMPUTER-READABLE STORAGE MEDIUM

(71) Applicant: Mitsubishi Electric Corporation, Chiyoda-ku, Tokyo (JP)

(72) Inventors: Ryuki NAKAMURA, Chiyoda-ku, Tokyo (JP); Yuka YOKOBORI, Chiyoda-ku, Tokyo (JP); Yoshihiro HOSOKAWA, Chiyoda-ku, Tokyo (JP)

(73) Assignee: Mitsubishi Electric Corporation, Chiyoda-ku, Tokyo (JP)

(21) Appl. No.: 18/713,024

(22) PCT Filed: Jan. 18, 2023
(86) PCT No.: PCT/JP2023/001248

§ 371 Date: May 23, 2024

(30) Foreign Application Priority Data
Jan. 25, 2022 (JP) 2022-009050

(51) Int. Cl. B29C 45/76

(52) U.S. Cl. CPC B29C 45/7693; B29C 2945/76287

(57) ABSTRACT

This injection molding method includes the steps of: constructing a prediction model on the basis of an input parameter including a molding condition for a molding product and an objective variable value including a quality value that quantifies a required quality of the molding product with respect to the input parameter; inferring a predictive distribution of the objective variable value with respect to the input parameter, using the prediction model; and deriving such a molding condition that satisfies the required quality of the molding product, by a Bayesian optimization method utilizing a regression model for obtaining the input parameter that yields a quality value highest in evaluation of the objective variable value as compared to an initial quality value, on the basis of the predictive distribution.

### TECHNICAL FIELD

The present disclosure relates to an injection molding method, a molding condition derivation device, and a computer-readable storage medium.

### BACKGROUND ART

An injection molding method is for molding a resin part by injecting a molten resin material into a mold, and is widely used in practice. In injection molding, in order to mold a high-quality resin part (hereinafter, molding product) that satisfies a required quality, work for deriving a proper molding condition is essential. However, a proper molding condition differs depending on differences in the shape of a molding product, the nature of used resin, and the like, and therefore the work for deriving the molding condition is performed by a skilled worker having a lot of knowledge and experience.

As a conventional method for assisting molding by an injection molding machine, a method of optimizing a molding product quality using a neural network has been proposed. For constructing the neural network, a molding condition is set as an input parameter, and a quality value obtained by measuring a good-quality molding product is set as an output item (hereinafter, referred to as objective variable) (see, for example, Patent Document 1).

### CITATION LIST

### Patent Document

Patent Document 1: Japanese Laid-Open Patent Publication No. 2008-110486

### SUMMARY OF THE INVENTION

### Problem to be Solved by the Invention

In general, work for deriving a proper molding condition that satisfies a required quality of a molding product is performed by a skilled worker having a lot of knowledge and experience. On the other hand, in a case where a worker having less knowledge and experience derives a molding condition, the worker goes through repetition of trial and error, thus taking a lot of time to derive a molding condition.

In addition, in a case of using a neural network as shown in the conventional method, there is a problem that a large number of training data including about several hundred to several ten thousand data are needed for constructing a prediction function for adjusting the molding condition.

Further, in the conventional method, for performing adjustment of the molding condition, measured quality values (product weight, warpage, dimension, etc.) are used, but in a case of using quality values (sink mark, flow mark, etc.) that require measurement by a high-resolution measurement device, the measurement device is expensive and therefore is difficult to prepare, and work for cutting out a measurement sample is needed. Thus, measurement cannot be easily performed.

The present disclosure has been made to solve the above problems, and an object of the present disclosure is to provide an injection molding method, a molding condition derivation device, and a computer-readable storage medium that can easily obtain a proper molding condition that satisfies a quality required for a molding product without depending on the skill level of a molding worker.

### Means to Solve the Problem

An injection molding method according to the present disclosure includes the steps of: constructing a prediction model on the basis of an input parameter including a molding condition for a molding product and an objective variable value including a quality value that quantifies a required quality of the molding product with respect to the input parameter; inferring a predictive distribution of the objective variable value with respect to the input parameter, using the prediction model; and deriving such a molding condition that satisfies the required quality of the molding product, by a Bayesian optimization method utilizing a regression model for obtaining the input parameter that yields a quality value highest in evaluation of the objective variable value as compared to an initial quality value, on the basis of the predictive distribution.

A molding condition derivation device according to the present disclosure is a molding condition derivation device for performing adjustment of a molding condition for a molding product on the basis of the above injection molding method, the molding condition derivation device including: a storage unit in which information about the molding condition and a required quality of the molding product is stored in advance; and a control processing unit. The control processing unit includes: a direct quality value processing unit which obtains a direct quality value by directly measuring the molding product; an indirect quality value processing unit which obtains an indirect quality value including a feature quantity converted from data of a sensor provided in a mold of an injection molding machine or an outer appearance image of the molding product; and a molding-condition adjustment unit which takes in, as a quality value, at least one of the direct quality value from the direct quality value processing unit or the indirect quality value from the indirect quality value processing unit, and derives such a molding condition that satisfies an optimum required quality of the molding product, by a Bayesian optimization method utilizing a regression model, using the quality value that has been taken in and the information about the molding condition and the required quality stored in the storage unit.

A computer-readable storage medium according to the present disclosure is a computer-readable storage medium having stored therein a computer program configured to, when the computer program is executed by a processor, execute the steps of: constructing a prediction model on the basis of an input parameter including a molding condition for a molding product and an objective variable value including a quality value that quantifies a required quality of the molding product with respect to the input parameter; inferring a predictive distribution of the objective variable value with respect to the input parameter, using the prediction model; and deriving such a molding condition that satisfies the required quality of the molding product, by a Bayesian optimization method utilizing a regression model for obtaining the input parameter that yields a quality value highest in evaluation of the objective variable value as compared to an initial quality value, on the basis of the predictive distribution.

Another injection molding method according to the present disclosure includes the steps of: constructing a prediction model on the basis of an input parameter including a molding condition for a molding product, and objective variable values including a feature quantity of a sensor value of a sensor provided to an injection molding machine with respect to the input parameter and a similarity of the sensor value when the molding condition for the molding product is changed with respect to a reference sensor value which is the sensor value when the molding product satisfies a required quality; inferring predictive distributions of the objective variable values with respect to the input parameter, using the prediction model; and deriving such a molding condition that satisfies the required quality of the molding product, by a Bayesian optimization method utilizing a regression model for obtaining the input parameter with which evaluation of the objective variable values indicates becoming closer to a feature quantity of the reference sensor value as compared to a feature quantity of an initial sensor value, on the basis of the predictive distributions.

Another molding condition derivation device according to the present disclosure is a molding condition derivation device for performing adjustment of a molding condition for a molding product on the basis of the above injection molding method, the molding condition derivation device including: a storage unit in which information about the molding condition and a required quality of the molding product is stored in advance; and a control processing unit. The control processing unit includes: a sensor value feature quantity processing unit which calculates the feature quantity of the sensor value obtained from the sensor value, and the similarity of the sensor value with respect to the reference sensor value; and a molding-condition adjustment unit which takes in the feature quantity of the sensor value and the similarity of the sensor value with respect to the reference sensor value from the sensor value feature quantity processing unit, and derives such a molding condition that satisfies an optimum required quality of the molding product, by a Bayesian optimization method utilizing a regression model, using the feature quantity of the sensor value and the similarity of the sensor value with respect to the reference sensor value which have been taken in and the information about the molding condition and the required quality stored in the storage unit.

Another computer-readable storage medium according to the present disclosure is a computer-readable storage medium having stored therein a computer program configured to, when the computer program is executed by a processor, execute the steps of: constructing a prediction model on the basis of an input parameter including a molding condition for a molding product, and objective variable values including a feature quantity of a sensor value of a sensor provided to an injection molding machine with respect to the input parameter and a similarity of the sensor value when the molding condition for the molding product is changed with respect to a reference sensor value which is the sensor value when the molding product satisfies a required quality; inferring predictive distributions of the objective variable values with respect to the input parameter, using the prediction model; and deriving such a molding condition that satisfies the required quality of the molding product, by a Bayesian optimization method utilizing a regression model for obtaining the input parameter with which evaluation of the objective variable values indicates becoming closer to a feature quantity of the reference sensor value as compared to a feature quantity of an initial sensor value, on the basis of the predictive distributions.

### Effect of the Invention

The injection molding method, the molding condition derivation device, and the computer-readable storage medium according to the present disclosure can construct a prediction function for adjusting a molding condition, even with a small number of data. Thus, it is possible to easily derive a molding condition that satisfies a required quality, without depending on the skill level of a molding worker.

### BRIEF DESCRIPTION OF THE DRAWINGS

FIG. 1 shows an example of a device configuration needed for implementing an injection molding method according to embodiment 1.

FIG. 2 shows an example of a device configuration needed for implementing the injection molding method according to embodiment 1.

FIG. 3 schematically shows an example of setting width information for a molding condition.

FIG. 4 schematically shows an example of item influence degrees of the molding condition.

FIG. 5 schematically shows an example of molding product information.

FIG. 6 is a characteristic graph showing an example of a correlation between a defined sink mark feature quantity and a sink mark amount.

FIG. 7A, FIG. 7B, and FIG. 7C illustrate examples of image processing performed on images of molding products.

FIG. 8 is graphs schematically showing a method for determining a next search condition (molding condition) using an EI value.

FIG. 9 is graphs schematically showing a method for determining a still next search condition (molding condition) using an EI value.

FIG. 10 is a flowchart showing an example of a sequential processing procedure for molding condition adjustment in the injection molding method according to the present disclosure.

FIG. 11 is a flowchart showing the example of the sequential processing procedure for molding condition adjustment in the injection molding method according to the present disclosure.

FIG. 12 is a flowchart showing the example of the sequential processing procedure for molding condition adjustment in the injection molding method according to the present disclosure.

FIG. 13 is a flowchart showing the example of the sequential processing procedure for molding condition adjustment in the injection molding method according to the present disclosure.

FIG. 14 illustrates an example of a screen of a molding condition derivation program which operates on a molding condition derivation device.

FIG. 15 illustrates an example of a screen of the molding condition derivation program to which quality values have been inputted after completion of molding for the number of initial data.

FIG. 16 illustrates an example of a screen of the molding condition derivation program for which adjustment has been executed for the first time.

FIG. 17 shows an example of a hardware configuration of a control processing unit of the present disclosure.

FIG. 18 is a block diagram showing the details of the control processing unit of the molding condition derivation device according to embodiment 1.

FIG. 19 is a flowchart showing steps executed by the control processing unit of the molding condition derivation device according to embodiment 1.

FIG. 20 shows an example of a device configuration needed for implementing an injection molding method according to embodiment 2.

FIG. 21 shows an example of a device configuration needed for implementing the injection molding method according to embodiment 2.

FIG. 22 shows an example of feature quantities in an X direction and a Y direction of a sensor value acquired in the control processing unit of the present disclosure.

FIG. 23 shows an example of a calculation result having a low similarity to a reference sensor value in the control processing unit of the present disclosure.

FIG. 24 shows an example of a calculation result having a high similarity to the reference sensor value in the control processing unit of the present disclosure.

FIG. 25 is a flowchart showing an example of a sequential processing procedure for performing prior preparation for molding condition adjustment in the injection molding method according to embodiment 2.

FIG. 26 is a flowchart showing an example of a sequential processing procedure for performing molding condition adjustment in the injection molding method according to embodiment 2.

FIG. 27 is a flowchart showing the example of the sequential processing procedure for performing molding condition adjustment in the injection molding method according to embodiment 2.

FIG. 28 is a flowchart showing the example of the sequential processing procedure for performing molding condition adjustment in the injection molding method according to embodiment 2.

FIG. 29 is a flowchart showing an example of a sequential processing procedure for acquiring feature quantities of a sensor value in the injection molding method according to embodiment 2.

FIG. 30 illustrates an example of a screen of a molding condition derivation program in embodiment 2.

FIG. 31 illustrates an example of a screen of the molding condition derivation program to which feature quantities of a sensor value have been inputted after completion of molding for the number of initial data in embodiment 2.

FIG. 32 illustrates an example of a screen of the molding condition derivation program for which adjustment has been executed for the first time in embodiment 2.

FIG. 33 is a block diagram showing the details of the control processing unit of the molding condition derivation device according to embodiment 2.

FIG. 34 is a flowchart showing steps executed by the control processing unit of the molding condition derivation device according to embodiment 2.

### DESCRIPTION OF EMBODIMENTS

The present disclosure relates to an injection molding method and a molding condition derivation device using a regression model that can obtain a posterior distribution of an output with respect to an input. Hereinafter, detailed description will be given using embodiments.

### Embodiment 1

### [Configuration for Implementing Injection Molding Method]

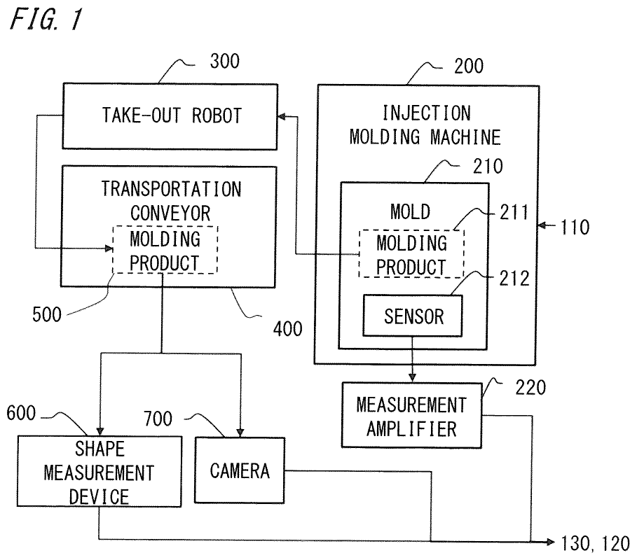

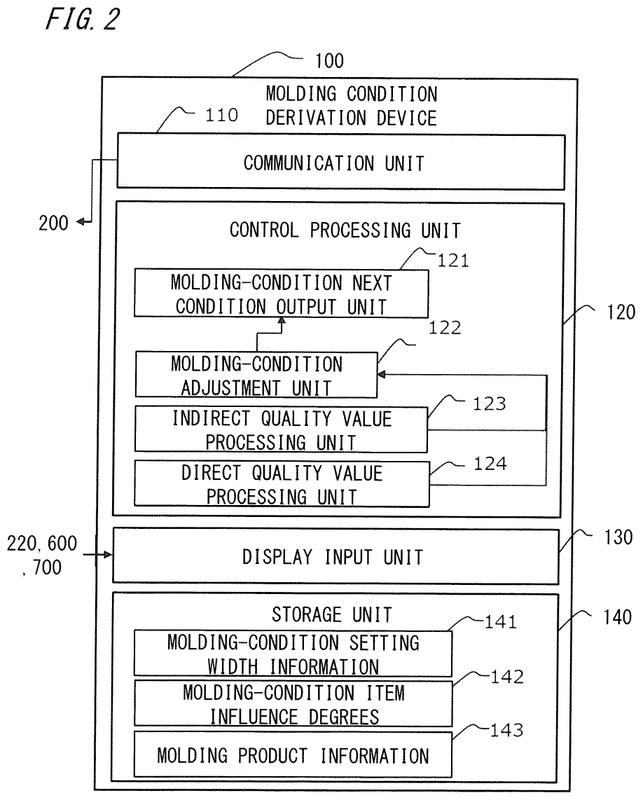

First, a configuration for performing the injection molding method according to the present disclosure will be described with reference to FIG. 1 and FIG. 2.

FIG. 1 and FIG. 2 show examples of device configurations needed for implementing the injection molding method according to embodiment 1.

As shown in FIG. 1, an injection molding machine 200 includes a mold 210 for molding a molding product 211, and various sensors 212 are attached to the mold 210. Data measured by each sensor 212 passes through a measurement amplifier 220 and then is taken into a control processing unit 120 of a molding condition derivation device 100 described later.

Meanwhile, the molding product 211 molded in the mold 210 is taken out by a take-out robot 300. The taken-out molding product 500 is placed on a transportation conveyor 400. Then, the molding product 500 is measured by a shape measurement device 600 and a photograph of the outer appearance thereof is captured by a camera 700. The measurement result by the shape measurement device 600 and the outer appearance photograph captured by the camera 700 are taken into the control processing unit 120 of the molding condition derivation device 100 described later.

The details of the configuration in FIG. 1 will be described later.

As shown in FIG. 2, the molding condition derivation device 100 of embodiment 1 includes a communication unit 110, a control processing unit 120, a display input unit 130, and a storage unit 140.

In this case, the molding condition derivation device 100 may be a single device, may be formed of a plurality of devices connected via a network such as a wide area network (WAN) or a local area network (LAN), or may be formed as a system. The molding condition derivation device 100 may be realized by a plurality of computer devices or a system using distributed computing or cloud computing.

The communication unit 110 includes a communication interface such as a network interface card (NIC), and a direct memory access (DMA) controller, for example. The communication unit 110 can communicate with the injection molding machine 200 via a network such as a WAN or a LAN.

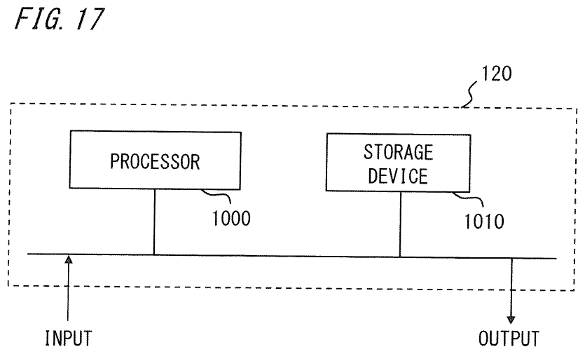

The control processing unit 120 includes a molding-condition next condition output unit 121, a molding-condition adjustment unit 122, an indirect quality value processing unit 123, and a direct quality value processing unit 124. As shown in a hardware configuration example in FIG. 17, the control processing unit 120 is composed of a processor 1000 such as a central processing unit (CPU) or a graphics processing unit (GPU), and a storage device 1010 (storage unit 140 described later), and is implemented by the processor 1000 executing a program stored in the storage device 1010 (storage unit 140 described later). Components of the control processing unit 120 may be formed by hardware such as a field programmable gate array (FPGA) or may be formed by both of software and hardware.

The display input unit 130 includes a display device such as a liquid crystal display, and can be used by a molding worker who uses the molding condition derivation device 100, to confirm progress of molding condition adjustment and perform setting and operation through a graphical user interface (GUI).

The storage unit 140 includes, for example, a hard disc drive (HDD), a solid state drive (SSD), a read only memory (ROM), a random access memory (RAM), and the like. Then, the storage unit 140 stores various programs such as firmware and an application program for deriving a molding condition, and in addition, molding-condition setting width information 141, molding-condition item influence degrees 142, and molding product information 143 described later.

As shown in FIG. 1, the injection molding machine 200 includes the mold 210 as a tool for molding the molding product 211 which is a target of molding condition adjustment, and various sensors 212 are attached to the mold 210.

The sensors 212 include a pressure sensor of a strain type or a piezoelectric type which measures a resin pressure, a strain gauge which measures a strain amount of the mold 210, a temperature sensor of a thermocouple type or an infrared type which measures the temperature of the mold 210 and a resin temperature, an acoustic emission (AE) sensor which detects radiation of acoustic waves in the mold 210, and the like. The types of the sensors 212 are not limited as long as they can be attached to the mold 210. Various sensor data measured by each sensor 212 passes through the measurement amplifier 220 and then is taken into the control processing unit 120, and thus is converted to a quality value for evaluating the quality of the molding product, in the indirect quality value processing unit 123.

The molding product 211 molded in the mold 210 is taken out by the take-out robot 300. The taken-out molding product 500 is placed on the transportation conveyor 400, and then shape data such as a flatness and a dimension are measured by the shape measurement device 600. The shape measurement device 600 may be a measurement instrument such as a caliper or a height gauge, or may be a three-dimensional measurement machine of a contact type or a contactless type.

In addition, a photograph of the outer appearance of the taken-out molding product 500 is captured by the camera 700. In order to capture a photograph of the outer appearance of the molding product 500 by the camera 700, a light, a blackout screen, and a jig may be added as necessary. A single or a plurality of cameras 700 may be provided. The captured outer appearance photograph of the molding product 500 is taken into the control processing unit 120, and then is converted to a quality value for evaluating the quality of the molding product 211, in the indirect quality value processing unit 123.

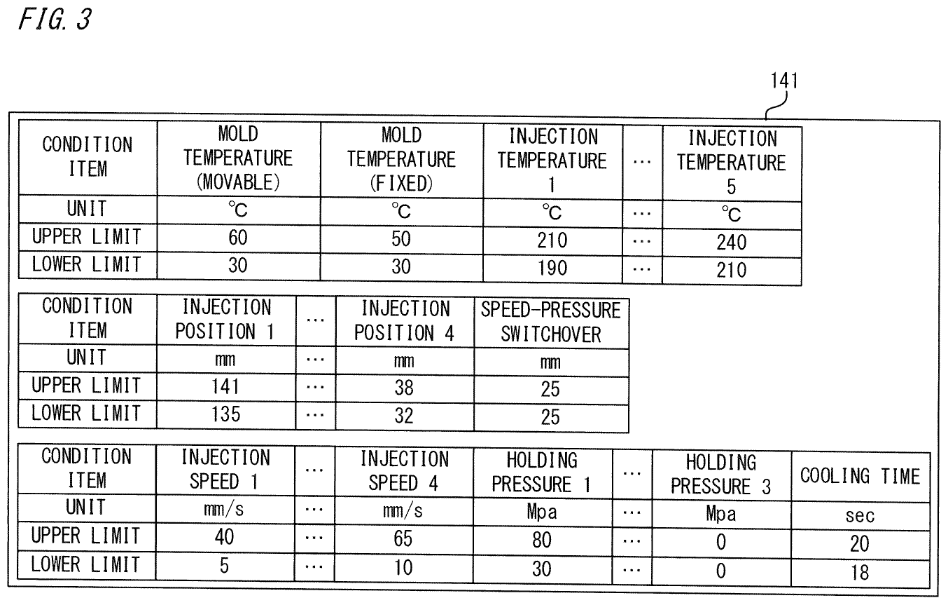

FIG. 3 schematically shows an example of the molding-condition setting width information 141 stored in the storage unit 140 in advance.

In the molding-condition setting width information 141, for each of various molding products 211, information of upper and lower limit values that can be set for setting items (input parameters) of the molding condition is set in advance. The upper and lower limit values may be set on the basis of experience and knowledge, or may be set on the basis of a result of resin flow analysis. For example, an injection temperature may be set in a temperature range recommended for each resin material by a resin material manufacturer, or may be set after whether or not the mold 210 is filled with resin is confirmed through resin flow analysis in advance. Alternatively, setting may be performed after whether or not there is a problem in molding is confirmed while test molding is actually performed.

Here, each item in FIG. 3 will be described.
Mold temperature (movable) is a parameter for controlling the temperature of the mold and “movable” indicates a die to move (open) when a molding product is taken out from the mold. The mold is provided with a pipe through which a fluid such as warm water, cold water, or oil flows, and the temperature of the fluid flowing in the pipe is controlled by a temperature adjuster, thereby controlling the mold temperature.
Mold temperature (fixed) is a parameter for controlling the temperature of the mold as in the above case and “fixed” indicates a die that does not move when a molding product is taken out from the mold. Such setting that provides a temperature difference between the movable side and the fixed side of the mold (e.g., movable side: 50° C., fixed side: 30° C.) is performed in general.
Injection temperatures 1 to 5 are parameters for controlling temperatures for melting pellets (granules) of resin to be injected into the mold. A heating cylinder of the injection molding machine is provided with thermocouples at four to six locations arranged in order from the front end of an injection unit, and the above numbers “1 to 5” indicate the locations of the thermocouples. The injection molding machine controls a heater of the heating cylinder so that the thermocouples reach the set temperature values. The set values are determined with reference to a range recommended by a resin material manufacturer, while confirming a production cycle time or the quality of the molding product.
Injection positions 1 to 4 are parameters for controlling a screw position of the injection molding machine to switch the speed for injecting molten resin into the mold. Flow of resin to be injected is controlled using a combination of the injection speed and the injection position. The numbers “1 to 4” represent how many positions are set as positions for switching the injection speed (e.g., the injection speed is 50 mm/s in a range to an injection position (screw position) 100 mm, and the injection speed is 30 mm/s in a range between injection positions 100 mm and 40 mm).
Speed-pressure switchover is setting for a screw position at which control of the screw of the injection molding machine is switched from injection speed control to holding pressure control in injecting molten resin into the mold.
Injection speeds 1 to 4 are parameters for controlling the speed for injecting molten resin into the mold, and flow of resin to be injected is controlled using a combination of the injection speed and the injection position. The numbers “1 to 4” represent to what levels the injection speed is changed at the respective injection positions.
Holding pressures 1 to 3 are parameters for setting a magnitude in holding pressure control after injection speed control in injecting molten resin into the mold. In general, in injection molding, after resin is injected into the mold in the injection speed control, shrinkage occurs along with state change (from liquid to solid) of the resin, and for compensating for resin shrinkage, molten resin is additionally injected into the mold by the holding pressure control. The numbers “1 to 3” represent at what stages and to what levels the holding pressure is changed in a case of applying the holding pressure in multiple stages. Control for each holding pressure is time-based control (e.g., the holding pressure 1 is 50 Mpa for 3 s, and the holding pressure 2 is 30 Mpa for 4 s).
A cooling time is a time during which molten resin is cooled and solidified after the holding pressure is applied to the resin in the mold. In general, during the cooling time, no pressure is applied to the resin from the outside, and only heat exchange takes place until the molten resin is solidified. If the cooling time is too short, warpage deformation or failure in release from the mold occurs, and if the cooling time is too long, increase in a production cycle time (increase in molding product cost) or failure in release from the mold occurs.

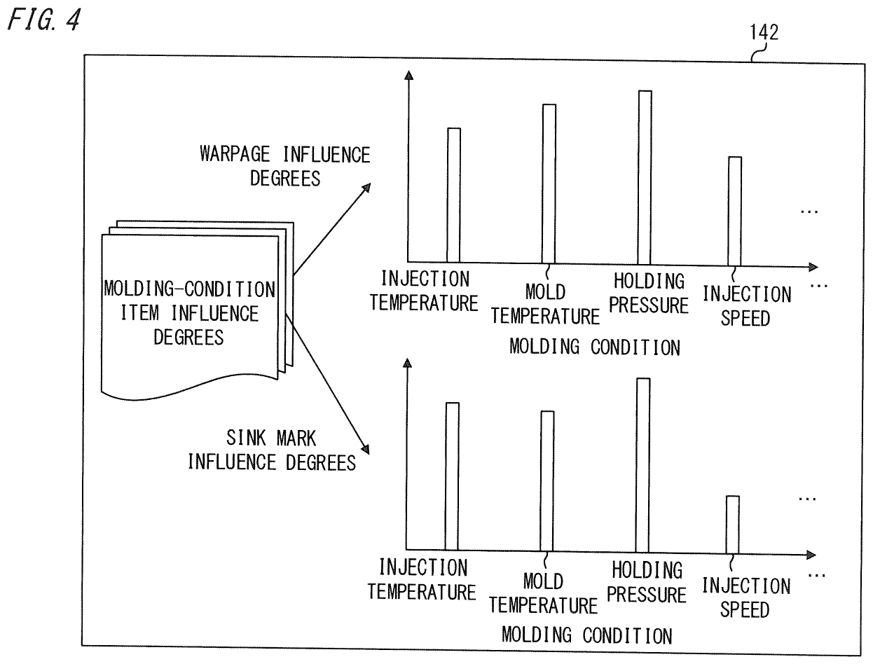

FIG. 4 schematically shows the molding-condition item influence degrees 142 stored in the storage unit 140 in advance.

In the molding-condition item influence degrees 142, the magnitude of an influence degree of each item (e.g., temperature, pressure, and injection speed) of the molding condition for quality values (e.g., warpage and sink mark) of the target molding product 211, is set. The influence degrees in this case may be set on the basis of experience and knowledge or may be set on the basis of a result of resin flow analysis. Alternatively, setting may be performed on the basis of a result of test molding actually performed. For example, an orthogonal array having items of the molding condition as control factors is created, resin flow analysis is performed on each condition, and a characteristic value with respect to a quality value of a molding product is calculated. On the basis of the characteristic value, the molding-condition item influence degree may be set. Also in a case of performing test molding, the influence degree may be set using an orthogonal array.

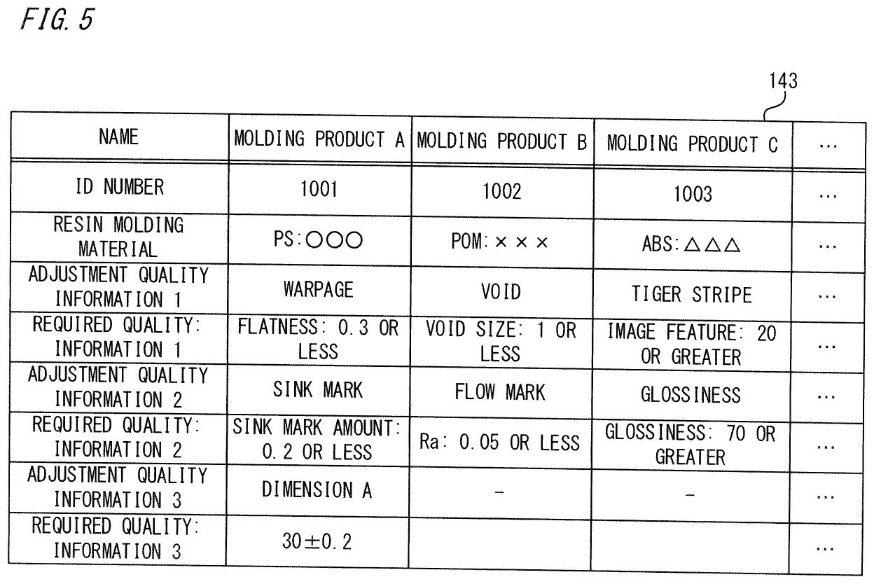

FIG. 5 schematically shows the molding product information 143 stored in the storage unit 140 in advance.

In the molding product information 143, for each of various molding products 211, information such as an ID number for individual identification, a resin molding material to be used, and required qualities of the molding product 211 for which adjustment is needed, is set individually. For quality information of the molding product 211, a desired number of qualities among the required qualities for the molding product 211 can be set. For example, for a molding product A in FIG. 5, warpage, sink mark, and a dimension of the molding product A are set as quality information. In this case, for example, warpage (information 1) is set by a flatness at an arbitrary measurement location, sink mark (information 2) is set by a dent amount at an arbitrary measurement location, and a dimension (information 3) is set by a dimension value and a dimensional tolerance.

For realizing the configuration of the present disclosure, the sensor 212, the measurement amplifier 220, the shape measurement device 600, and the camera 700 are devices for quantifying the quality of the molding product 211, and at least any of these may be used.

By realizing the above configuration, the injection molding method of the present disclosure can be implemented.

### [Quantification of Quality of Molding Product]

In order to obtain an optimum molding condition that satisfies a required quality of the molding product 211 (hereinafter, referred to as molding condition parameter adjustment), it is necessary to consider an optimization problem for adjusting the relationship between input and output. In the present embodiment 1, the input is a value of the molding condition and the output is a required quality of the molding product. While a value of the molding condition as the input is a quantitative value, a required quality of the molding product as the output may be represented by a result of visual confirmation or a feeling by a molding worker and in some cases, is not defined as a quantitative value. Accordingly, first, a method for acquiring a quality value that quantifies a required quality of the molding product 211 will be described.

In the present embodiment 1, quality values such as a dimension and warpage which can be easily measured are defined as direct quality values. On the other hand, quality values such as sink mark and a flow mark which are difficult to measure are quantified by being replaced with a feature quantity extracted from a value of the sensor 212 provided in the mold 210 or a feature quantity based on an image captured by the camera 700, and these feature quantities are defined as indirect quality values. In a case of acquiring sink mark and a flow mark as direct quality values, it is necessary to perform measurement by a high-resolution measurement machine, but in this case, the measurement machine is expensive and therefore is difficult to prepare, and work for cutting out a measurement sample is needed. Thus, measurement cannot be easily performed. Therefore, sink mark and a flow mark are taken as indirect quality values.

The direct quality values are obtained by directly measuring a dimension, a flatness, and the like of the molding product 211. For example, if a required quality prescribes that one dimension is within a dimensional tolerance, the dimension is measured by the shape measurement device 600 (a measurement device such as a caliper or a three-dimensional measurement machine), and the measured value is used as the quality value for the required quality. As another example, in a case of a required quality for warpage, a quality value can be obtained by performing geometrical tolerance measurement for a value such as a flatness or a perpendicularity of an arbitrary surface.

The measured quality value is sent to the display input unit 130 by means of transmission through a network or a graphical user interface (GUI) input by a molding worker. Thereafter, in the control processing unit 120, the direct quality value processing unit 124 performs preprocessing (processing such as data coupling with another quality value and conversion into array information) for performing Bayesian optimization described later.

On the other hand, the indirect quality values are obtained by converting a sensor value and an image acquired by the sensor 212 and the camera 700 with respect to the molding product 211, to quality values. For example, if a required quality prescribes that the sink mark amount is minimized, a sink mark feature quantity (defined as a logarithm of a value obtained by dividing a time integral value of a temperature sensor provided in the mold 210 by a time integral value of a pressure sensor) is used as a quality value.

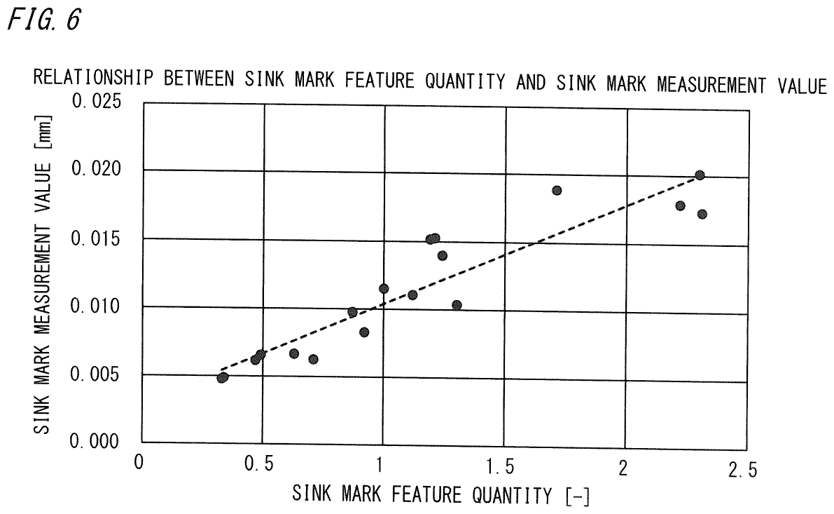

As shown in FIG. 6, the sink mark feature quantity has a direct-proportional correlation with the sink mark amount (sink mark measurement value) measured by a high-resolution measurement device, and has a relationship in which the sink mark amount (sink mark measurement value) is reduced as the sink mark feature quantity is reduced. As another example, if a required quality prescribes that a flow mark is minimized, an image of the taken-out molding product 500 captured by the camera 700 is subjected to grayscale processing, trimming, image smoothing through various low-pass filters for blurring the image, and the like, thus performing white-black binarization processing.

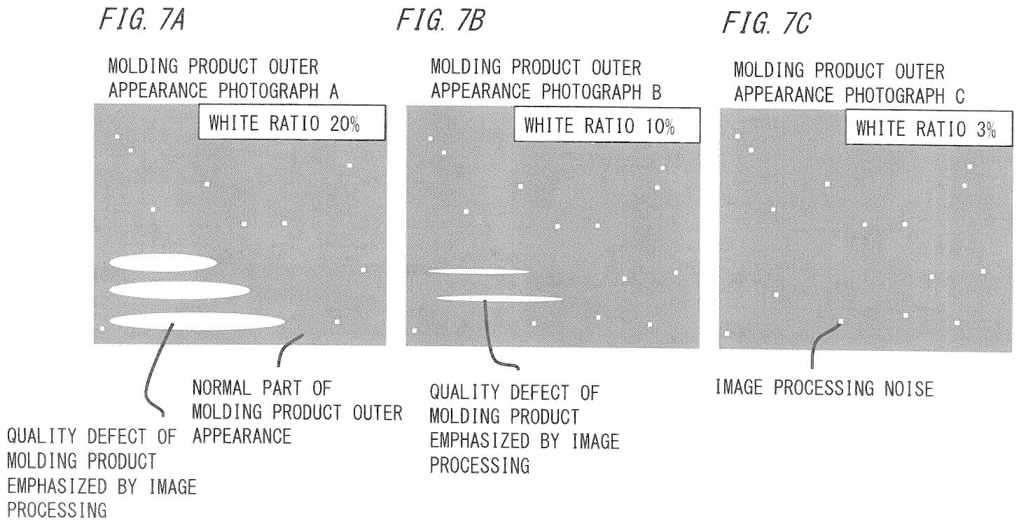

FIGS. 7A-7C illustrates examples of results of image processing performed on images of molding products.

In FIGS. 7A-7C, a case where a flow mark is large (FIG. 7A), a case where a flow mark is small (FIG. 7B), and a case where there is no flow mark (FIG. 7C), are shown side by side in order from left to right. The ratio of a white area in the image varies depending on the magnitude of the flow mark, and therefore the ratio of the white area can be used as a quality value for the flow mark.

As described above, by using quality values (direct quality values and indirect quality values) that quantify the required qualities of the molding product 211, it is possible to address an optimization problem with a value of a molding condition as an input and a required quality (quality value) of a molding product as an output.

### [Bayesian Optimization Method]

Before describing sequential processing of adjustment for a molding condition, the outline of a Bayesian optimization method used for deriving a molding condition that satisfies a required quality of the molding product 211 will be described.

The Bayesian optimization method is one of parameter optimization methods that can be applied even in a case where a function to be optimized is unknown. First, a prediction model is constructed on the basis of an input parameter (in the present embodiment 1, a molding condition) and an objective variable value (in the present embodiment 1, a quality value that quantifies a required quality of the molding product 211 described above) with respect to the input parameter. Then, by using the prediction model, a predictive distribution of an objective variable with respect to an input parameter to be considered is inferred. By using the predictive distribution, an input parameter (a molding condition to be performed next) that yields the highest evaluation so that the value of the objective variable becomes a desired value is presented. Through repetition of the above process, adjustment for the input parameter is performed.

As the prediction model used here, a model that can obtain a posterior distribution of an output with respect to an input (in the present embodiment 1, a Gaussian process regression model) is adopted. However, another regression model, e.g., a random forest regression model, may be used.

### [Gaussian Process Regression Model]

The Gaussian process regression is one of nonparametric regression methods, and can construct a prediction function with a comparatively small amount of data, as compared to neural network regression.

The Gaussian process regression is one of models that estimate an objective function y=f(x) from an input variable x to a real-number value y which is an objective variable.

Specifically, this is a model that calculates a predictive distribution P(f(xₜ₊₁)|D_{1:t}, xₜ₊₁) of an objective function f(xₜ₊₁) which is a search target when data D_{1:t}={x_{1:t}, y_{1:t}} is given, by the following Formula (1).

$$\begin{matrix}[ Mathematical 1 ] & \\ P ( f ( {x}_{t + 1} ) \vert {D}_{1 : t} , {x}_{t + 1} ) = ( {μ}_{{x}_{t + 1}} \vert x 1 : t , {σ}^{2} {x}_{t + 1} \vert {x}_{1 : t} ) & ( 1 )\end{matrix}$$

The right-hand side of Formula (1) is a normal distribution (Gaussian distribution) with a mean value (expected value) denoted by μ_{xt+1|x1:t} and a variance denoted by σ²_{xt+1|x1:t}.

For example, in a Gaussian process regression model in a case where standardization is performed so that the mean of y becomes 0, a prediction mean and a prediction variance can be calculated by the following Formula (2) and Formula (3), where a covariance matrix K indicating a relationship of an input parameter x is expressed using an arbitrary kernel function k(x, x′).

$$\begin{matrix}[ Mathematical 2 ] & \\ {μ}_{{x}_{t + 1}} \vert x 1 : t = {k}_{*}^{T} {K}^{- 1} y & ( 2 )\end{matrix}$$

$$\begin{matrix}[ Mathematical 3 ] & \\ {σ}^{2} {x}_{t + 1} \vert {x}_{1 : t} = {k}_{**} - {k}_{*}^{T} {K}^{- 1} {k}_{*} & ( 3 )\end{matrix}$$

Here, k** denotes k(x*, x*), k* represents a vector of (k(x*, x₁), k(x*, x₂), . . . , k (x*, xₙ))^{T}, the matrix K represents an N×N covariance matrix having elements k(xₙ, x′ₙ), and the vector y represents a vector of (y₁, y₂, . . . , yₙ). In the present embodiment 1, as the kernel function k(x, x′), a Gaussian kernel represented by the following Formula (4) (Θ₁ and Θ₂ are parameters that determine the nature of a kernel) is used. As another example, any of an exponential kernel, a periodic kernel, or a Matern kernel may be used.

$$\begin{matrix}[ Mathematical 4 ] & \\ k ( x , {x}^{′} ) = {Θ}_{1} exp ( - \frac{{\vert x - {x}^{′} \vert}^{2}}{{Θ}_{2}} ) & ( 4 )\end{matrix}$$

### [Parameter Search Method by Bayesian Optimization]

In the Bayesian optimization method, in order to determine input parameters (molding condition) to be verified next, an acquisition function for performing evaluation for a combination of input parameter candidates is used. For the acquisition function, for example, probability of improvement (PI) or expected improvement (EI) may be used. Alternatively, upper confidence bound (UCB) or mutual information (MI) may be used.

In the present embodiment 1, as an example, a case where an acquisition function called expected improvement (EI) for calculating an expected value for how much improvement will be made from an objective variable minimum (maximum) value is used in association with a plurality of objective variables, will be described.

In a case of a minimization problem of an objective function y=f(x), Bayesian optimization using an EI value determines a search condition that maximizes an expected value of improvement represented by the following Formula (5), as the next search condition.

$$\begin{matrix}[ Mathematical 5 ] & \\ E [ I ( x ) ] ≡ E [ max ( {f}_{min} - Y , 0 ) ] & ( 5 )\end{matrix}$$

As a specific calculation method for the EI value, the EI value may be calculated on the basis of the following Formula (6).

$$\begin{matrix}[ Mathematical 6 ] & \\ E [ I ( x ) ] = ( {f}_{min} - μ ( x ) ) Φ ( \frac{{f}_{min} - μ ( x )}{σ ( x )} ) + σ ( x ) φ ( \frac{{f}_{min} - μ ( x )}{σ ( x )} ) & ( 6 )\end{matrix}$$

In Formula (6), fₘᵢₙ denotes the minimum value of the objective function at the present number of times of searching, and μ(x) and σ(x) denote a prediction mean and a prediction standard deviation outputted from the Gaussian process regression model. In addition, Φ denotes a cumulative distribution function, and φ denotes a probability density function.

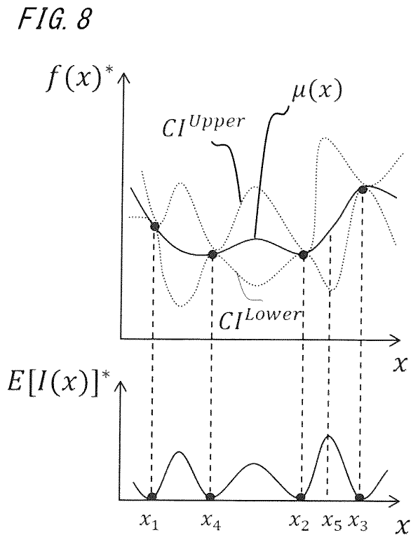

FIG. 8 shows schematic graphs about a method for determining the next search condition using the above EI value.

An upper graph in FIG. 8 shows a predictive distribution of the objective function f(x), black dots are already observed data points, μ(x) denotes a prediction mean, and CI^{Upper} and CI^{Lower} denote an upper limit and a lower limit of a confidence interval calculated from the prediction standard deviation.

A lower graph in FIG. 8 shows the calculated EI values, and EI values are small at black dots because they are already observed points.

According to the schematic graphs in FIG. 8, x₅ which exhibits the greatest EI value is used as the next search condition.

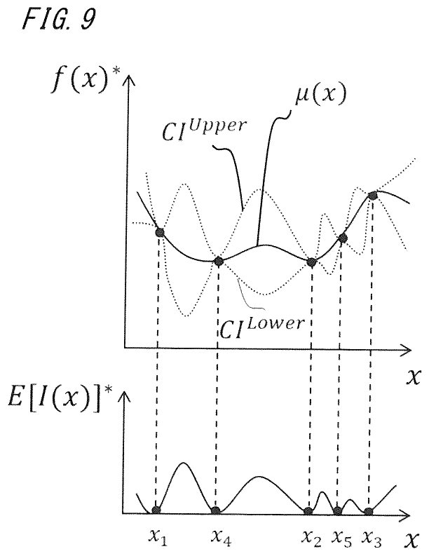

Subsequently, an upper graph in FIG. 9 shows a result after the next search condition is executed, and a lower graph in FIG. 9 shows a schematic graph about a method for determining a still next search condition.

Since a predictive distribution of x₅ used as the next search condition has been clarified, the EI value of x₅ becomes small.

As a result, the still next search condition is determined to be another search condition that yields a high EI value.

In this way, as shown in FIG. 8 and FIG. 9, a trial is repeatedly performed while determining a next search condition on the basis of an EI value, thus searching for an optimum input parameter.

In the present embodiment 1, there is a case of using a plurality of objective functions (e.g., a warpage amount, a sink mark amount, and a color difference of an outer appearance photograph of a molding product), and therefore these evaluation values (EI values) are synthesized to unify an acquisition function. As a method for unifying an evaluation value, a method of taking a weighted linear sum is used. Alternatively, a method of simply taking a sum or a product may be used.

### [Adjustment Method for Molding Condition]

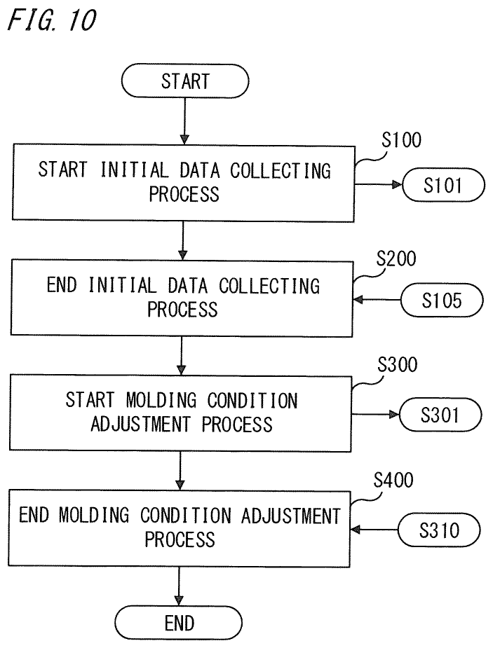

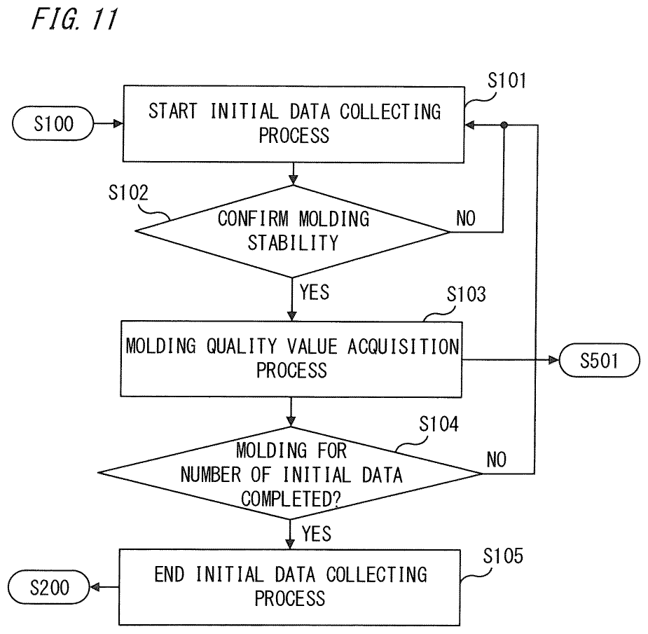

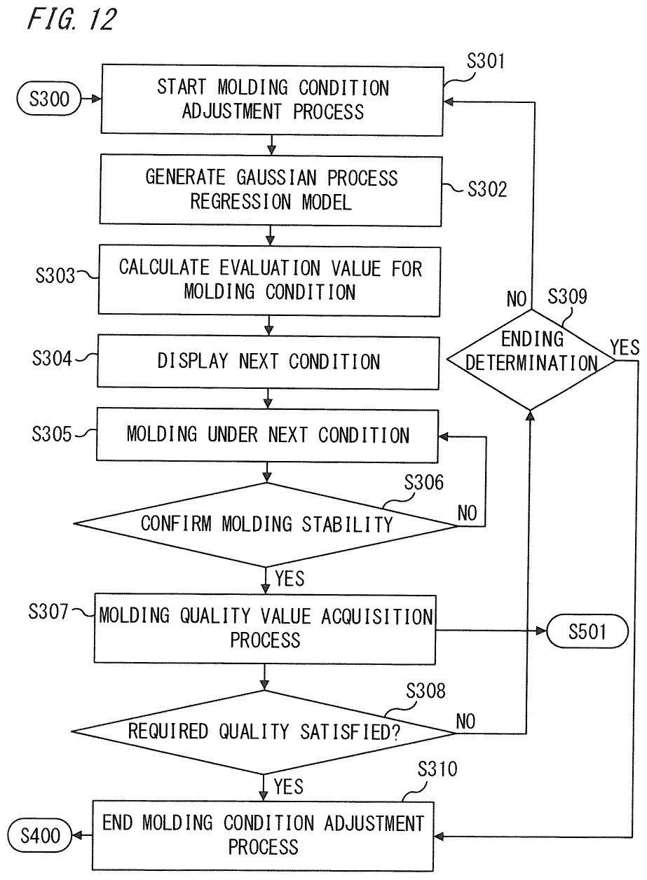

FIG. 10 to FIG. 13 are flowcharts showing an example of a sequential processing procedure for adjustment of the molding condition in the injection molding method of the present disclosure. Hereinafter, description will be given specifically, using a case where objective variables in adjustment are two variables of warpage and sink mark, as an example. In the drawings, “S” denotes steps.

In performing adjustment of the molding condition, an initial data collecting process is performed (step S100 and step S101). For this purpose, first, the molding condition derivation device 100 is started, and setting for the molding-condition setting width information 141, the molding-condition item influence degrees 142, and the molding product information 143 described above is performed. Then, the molding condition derivation program stored in the storage unit 140 is started.

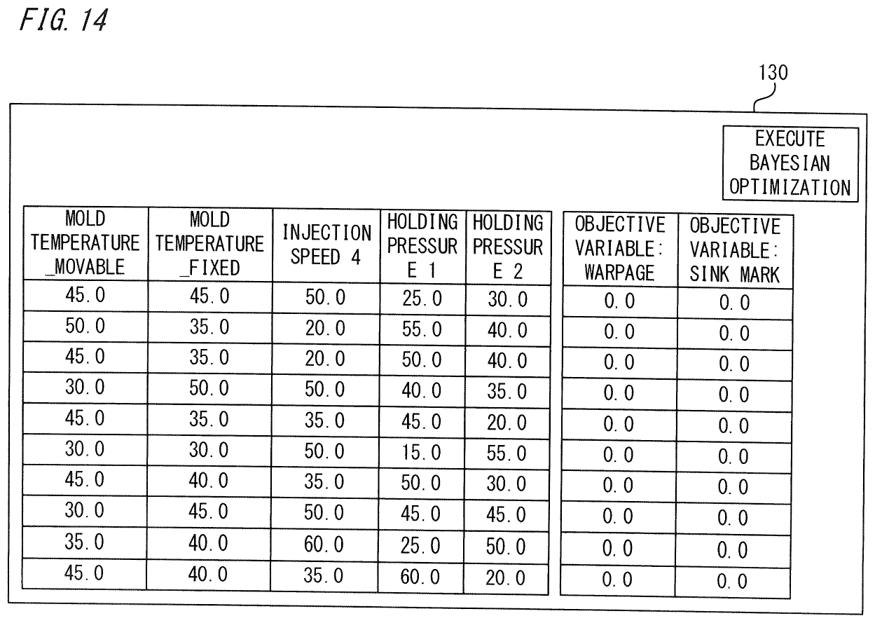

FIG. 14 shows a start screen of the molding condition derivation program in a case where there are five input parameters (mold temperature_movable, mold temperature_fixed, injection speed at fourth stage, holding pressure at first stage, and holding pressure at second stage) and two objective variables (objective variable 1: warpage, objective variable 2: sink mark), as an example.

When started, the molding condition derivation program stored in the storage unit 140 reads adjustment quality information of the molding product information 143 as objective variables, selects items of the molding condition serving as input parameters from the molding-condition item influence degrees 142, and creates an initial molding condition table as shown in FIG. 14 so as to fall within the ranges in the molding-condition setting width information 141. Then, the content thereof is displayed on the display input unit 130. FIG. 14 shows a case of such a setting that combinations of molding conditions are randomly outputted, but it is also possible to output a two-level orthogonal array with molding conditions as control factors. The molding worker may change a molding condition item serving as an input parameter, selected by the molding condition derivation program, to another molding condition item.

The molding worker performs molding work in accordance with the initial molding condition table shown in FIG. 14, displayed on the display input unit 130 of the molding condition derivation device 100. At this time, the molding condition may be manually inputted directly by the molding worker, or may be automatically inputted through the communication unit 110 if the injection molding machine 200 is connected via a network. The molding work is sequentially performed from the first row of the initial molding condition table in FIG. 14, to confirm molding stability (step S102).

In injection molding, after molding is started with a set molding condition or a molding condition changed subsequently, increase or decrease in the mold temperature gradually arises as the number of times of molding increases. Thereafter, while molding is performed a certain number of times, temperature change gradually decreases, so that it becomes possible to perform molding in the same mold temperature state. This state is used as a criterion for determining that the molding is stabilized.

As a specific confirmation method, the molding stability may be confirmed on the basis of transition of temporal change in the value of a temperature sensor attached to the mold or transition of change in a pressure value converted from a load cell of the molding machine. In the present embodiment 1, a fact that change in the value of the temperature sensor falls within a range of ±1° C. in three consecutive times of molding is a condition that molding stability is confirmed.

Next, in the state in which molding stability has been confirmed, a molding quality value is acquired on the obtained molding product 211 (step S103 and step S501). Time-series data of a temperature and a pressure acquired by the sensors 212 and the measurement amplifier 220 during molding are transmitted to the molding condition derivation device 100 (step S505). The transmitted time-series data is sent to the indirect quality value processing unit 123 and then is converted to a sensor feature quantity (sink mark feature quantity) described above (step S506 and step S507).

For the molding product 500 after molding, a flatness of a predetermined surface is measured by the shape measurement device 600 (step S502 and step S503). The measured flatness is inputted via a graphical user interface (GUI) of the display input unit 130 by the molding worker or is directly transmitted if the shape measurement device 600 is present on the same network, so as to be sent to the direct quality value processing unit 124 of the molding condition derivation device 100, and then the measured flatness is converted to a direct quality value (step S503 and step S504).

As for a required quality regarding the design of the molding product, e.g., a flow mark, a photograph of the outer appearance of the molding product 500 is captured by the camera 700 after molding, and the captured image is acquired (step S508) and transmitted to the molding condition derivation device 100. Then, in the indirect quality value processing unit 123, an indirect quality value is obtained on the basis of the above-described image processing (step S509 and step S510). When acquisition of necessary quality values has been completed, the molding quality value acquisition process is ended (step S511).

Next, the steps for performing molding under each molding condition of the injection molding initial molding condition table by driving the injection molding machine 200 and then acquiring molding quality values as objective variables, are repeated for a number of times corresponding to the number of initial data shown in the initial molding condition table (step S104).

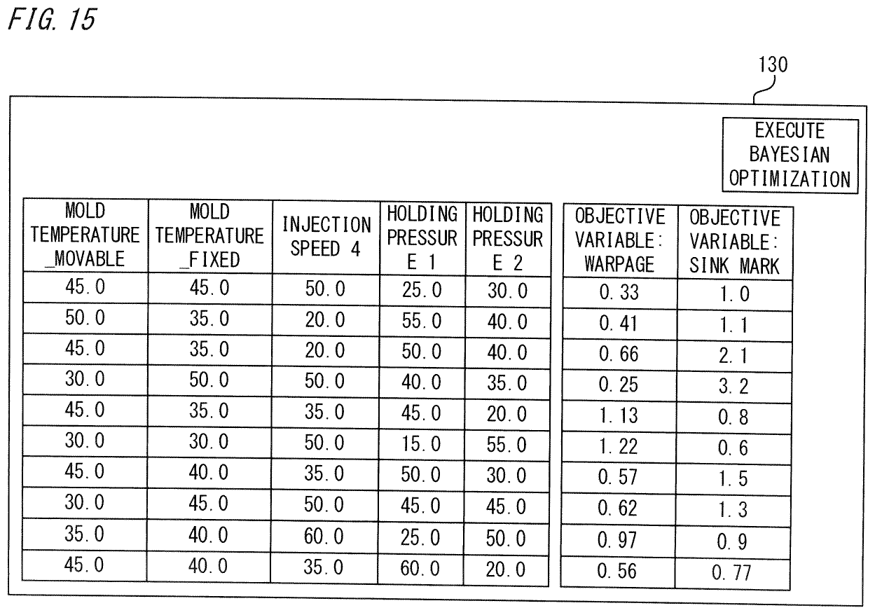

FIG. 15 illustrates an example of a screen of the molding condition derivation program in which the quality values have been inputted, when molding for the number of initial data has been completed.

As shown in FIG. 15, when molding for the number of initial data has been completed (step S105 and step S200), the molding-condition adjustment unit 122 starts a molding condition adjustment process (step S300).

When the molding condition adjustment process is started (step S300 and step S301), repetitive molding based on the Bayesian optimization method described above is performed to achieve molding condition adjustment. For this purpose, first, a Gaussian process regression model is generated using the input parameters (values of molding conditions) and the objective variables (quality values) collected in the initial data collecting process (step S302). That is, a prediction model (prediction function) is generated using the input parameters (values of molding conditions) and the objective variables (quality values). A combination of molding condition values with which molding has not been performed yet is inputted to the Gaussian process regression model generated as described above, to obtain a prediction mean value and a prediction standard deviation. Then, using an acquisition function EI (expected improvement), an evaluation value for the molding condition inputted to the Gaussian process regression model is calculated (step S303).

Here, inputted combinations of molding condition values with which molding has not been performed yet are all combinations based on arithmetic progressions created for the set input parameters within the upper-lower-limit ranges of the molding-condition setting width information 141. The molding condition that yields the highest evaluation value is displayed as a molding condition to be performed next, on the graphical user interface (GUI) of the display input unit 130 (step S304).

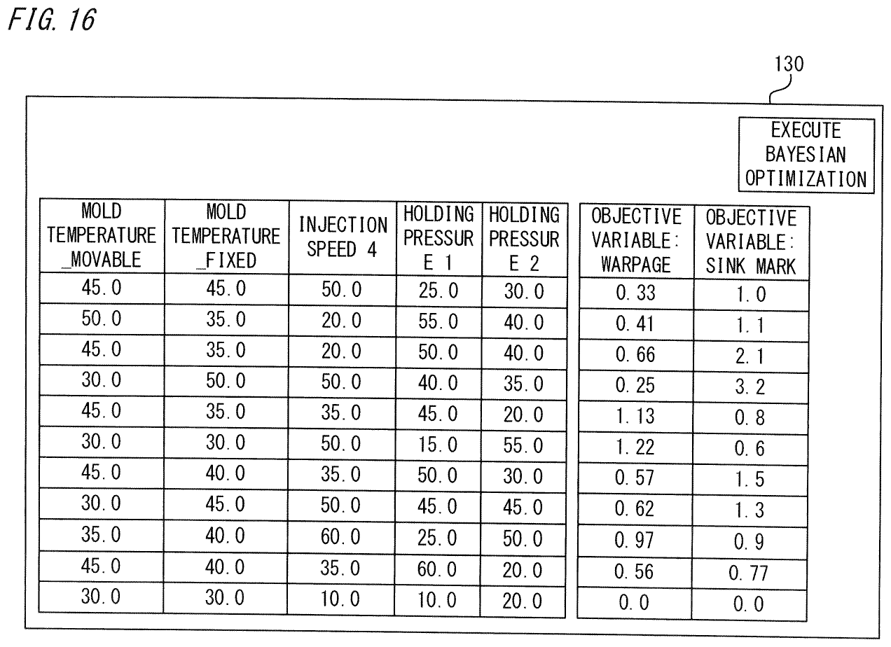

FIG. 16 illustrates an example of a screen of the molding condition derivation program on which the molding condition to be performed next is displayed.

In FIG. 16, the molding condition displayed at the last row is the molding condition to be performed next.

The processing of displaying the next molding condition as described above can be executed by clicking an “EXECUTE Bayesian OPTIMIZATION” button on the screen of the molding condition derivation program shown in FIG. 14 to FIG. 16.

Thereafter, as in the initial data collecting process, the injection molding machine 200 is driven to perform molding under the displayed molding condition (step S305). Similarly, confirmation for molding stability (step S306) and acquisition of molding quality values (step S307) are also performed. Then, if the acquired quality values satisfy the required qualities (step S308), the molding condition adjustment process is ended (step S310 and step S400). On the other hand, if the required qualities are not satisfied, an ending determination (step S309) is performed.

For the ending determination, in the present embodiment 1, setting is made so as to perform repetitive molding ten times as a designated number of times, but the number of times may be set arbitrarily. If the ending determination does not indicate end, the molding condition adjustment process is returned to start again (step S301), thus repeating the sequential flow. On the other hand, if the ending determination indicates end, the molding condition adjustment process is ended (step S310 and step S400).

As described above, in the present embodiment 1, a molding condition that satisfies a required quality of a molding product is derived by the Bayesian optimization method utilizing a regression model that can obtain a posterior distribution of an output with respect to an input, in particular, a Gaussian process regression model, whereby it is possible to construct a prediction function for adjusting a molding condition, even with a smaller number of data. Thus, it is possible to easily derive a proper molding condition that satisfies a quality required for a molding product, without depending on the skill level of a molding worker.

That is, the injection molding method according to embodiment 1 includes the following steps, and the computer-readable storage medium having stored therein a computer program according to embodiment 1 is configured to, when the computer program is executed by a processor, execute the following steps.

That is, the steps to be executed are the steps of:
constructing a prediction model on the basis of an input parameter including a molding condition for a molding product and an objective variable value including a quality value that quantifies a required quality of the molding product with respect to the input parameter;
inferring a predictive distribution of the objective variable value with respect to the input parameter, using the prediction model; and
deriving such a molding condition that satisfies the required quality of the molding product, by a Bayesian optimization method utilizing a regression model for obtaining the input parameter that yields a quality value highest in evaluation of the objective variable value as compared to an initial quality value, on the basis of the predictive distribution.

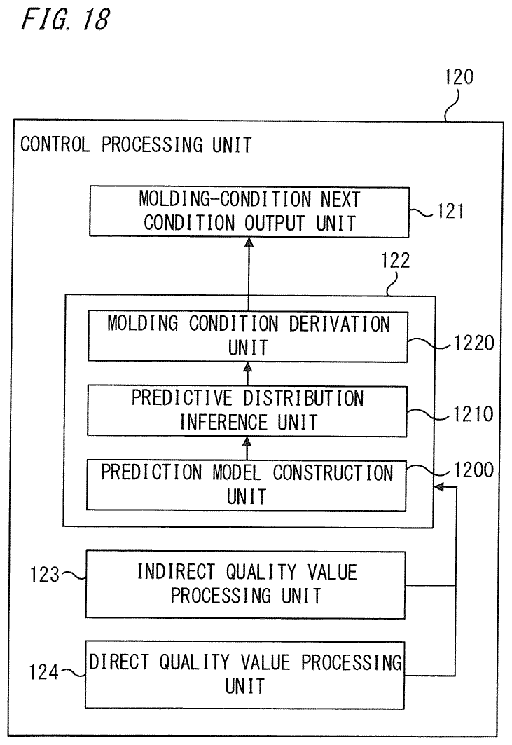

The injection molding method and the computer-readable storage medium described above are executed by, as shown in FIG. 18, the molding-condition adjustment unit 122 in the control processing unit 120 of the molding condition derivation device 100 in FIG. 1.

Then, the molding-condition adjustment unit 122 shown in FIG. 18 includes: a prediction model construction unit 1200 which constructs a prediction model on the basis of the input parameter including the molding condition for the molding product and the objective variable value including the quality value that quantifies the required quality of the molding product with respect to the input parameter; a predictive distribution inference unit 1210 which infers a predictive distribution of the objective variable value with respect to the input parameter, using the prediction model; and a molding condition derivation unit 1220 which derives such a molding condition that satisfies the required quality of the molding product, by the Bayesian optimization method utilizing the regression model for obtaining the input parameter that yields a quality value highest in evaluation of the objective variable value as compared to an initial quality value, on the basis of the predictive distribution.

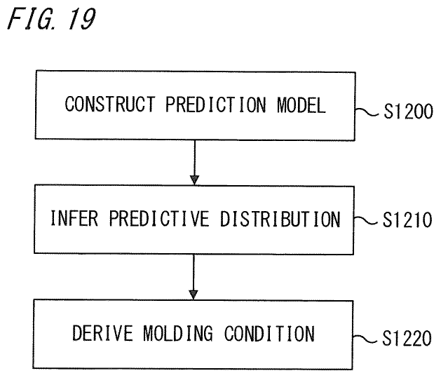

In addition, as shown in a flowchart in FIG. 19, the injection molding method according to embodiment 1 includes the following steps, and the computer-readable storage medium having stored therein a computer program according to embodiment 1 is configured to, when the computer program is executed by a processor, execute the following steps.

That is, as shown in FIG. 19, the steps to be executed are the steps of:
constructing a prediction model on the basis of an input parameter including a molding condition for a molding product and an objective variable value including a quality value that quantifies a required quality of the molding product with respect to the input parameter (step S1200);
inferring a predictive distribution of the objective variable value with respect to the input parameter, using the prediction model (step S1210); and
deriving such a molding condition that satisfies the required quality of the molding product, by a Bayesian optimization method utilizing a regression model for obtaining the input parameter that yields a quality value highest in evaluation of the objective variable value as compared to an initial quality value, on the basis of the predictive distribution (step S1220).

As described above, the control processing unit 120 is composed of, for example, as shown in the hardware configuration example in FIG. 17, the processor 1000 such as a central processing unit (CPU) or a graphics processing unit (GPU), and the storage device 1010 (storage unit 140), and is implemented by the processor 1000 executing the program stored in the storage device 1010 (storage unit 140).

Therefore, processing in the prediction model construction unit 1200, the predictive distribution inference unit 1210, and the molding condition derivation unit 1220 of the molding-condition adjustment unit 122 shown in FIG. 18 and processing in steps S1200, S1210, S1220 executed in the flowchart shown in FIG. 19, are implemented by the processor 1000 executing the program stored in the storage device 1010 (storage unit 140).

### Embodiment 2

### [Utilization of Feature Quantity of Sensor Value]

In embodiment 2, an injection molding method for performing proper-product maintenance and proper-product restoration, utilizing a feature quantity of a sensor value, will be described.

In order to obtain an optimum molding condition that satisfies a required quality of a molding product (referred to as molding condition parameter adjustment), as in embodiment 1, it is necessary to consider an optimization problem for adjusting the relationship between input and output.

In embodiment 2, for example, using, as a reference, a sensor value (hereinafter, referred to as a reference sensor value) in a mold in a proper-product case that satisfies a required quality, a molding condition is changed so as to match with the reference sensor value, on the basis of Bayesian optimization utilizing a feature quantity extracted from a sensor value as described later, whereby it is possible to maintain the proper-product state or return from a defective-product state to the proper-product state.

In the following description, as an example, a method for returning from a defective-product state to a proper-product state will be described.

### [Configuration for Implementing Injection Molding Method]

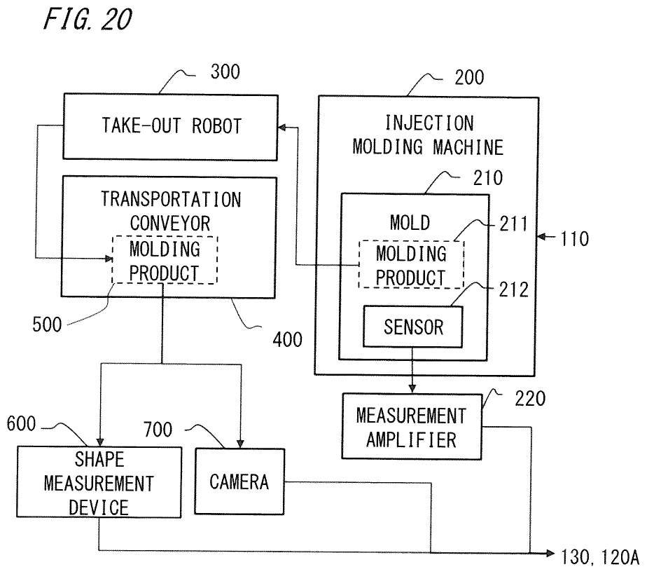

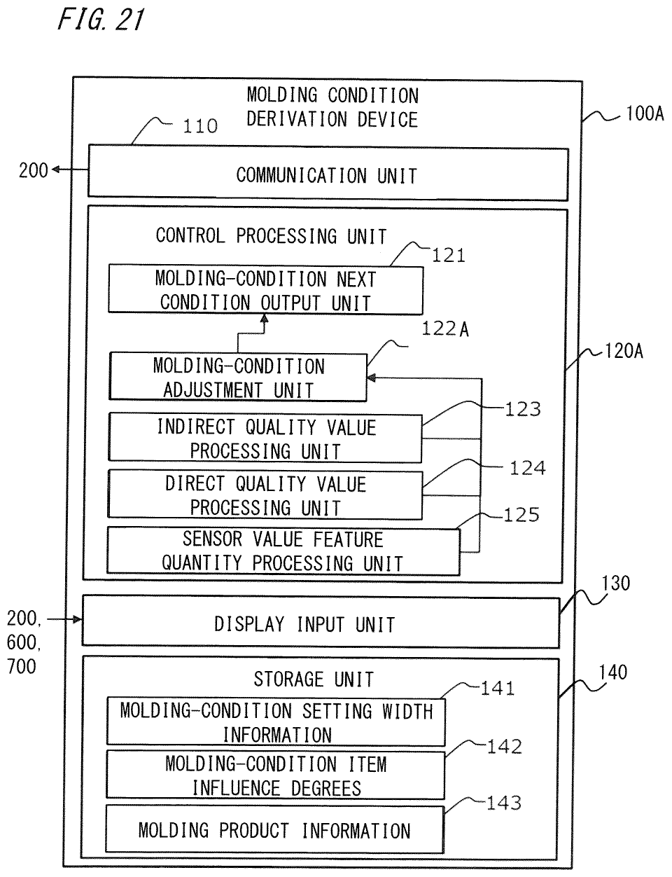

A configuration for implementing the injection molding method according to embodiment 2 will be described focusing on a difference from embodiment 1, with reference to FIG. 20 and FIG. 21.

FIG. 20 and FIG. 21 show examples of device configurations needed for implementing the injection molding method according to embodiment 2.

As shown in FIG. 20, the injection molding machine 200 includes the mold 210 for molding the molding product 211, and various sensors 212 are attached to the mold 210. Data measured by each sensor 212 passes through the measurement amplifier 220 and then is taken into a control processing unit 120A of a molding condition derivation device 100A described later.

The configuration in FIG. 20 is the same as that in FIG. 1 in embodiment 1, and therefore the detailed description thereof is omitted.

As shown in FIG. 21, the molding condition derivation device 100A includes the communication unit 110, a control processing unit 120A, the display input unit 130, and the storage unit 140.

The control processing unit 120A includes the molding-condition next condition output unit 121, a molding-condition adjustment unit 122A, the indirect quality value processing unit 123, the direct quality value processing unit 124, and a sensor value feature quantity processing unit 125.

The storage unit 140 includes the molding-condition setting width information 141, the molding-condition item influence degrees 142, and the molding product information 143.

As compared to the molding condition derivation device 100 in embodiment 1, the molding condition derivation device 100A of embodiment 2 is different in that the sensor value feature quantity processing unit 125 is provided in the control processing unit 120A.

Using the sensor value taken into the control processing unit 120A through the measurement amplifier 220, the sensor value feature quantity processing unit 125 calculates a feature quantity of the sensor value described later which is used for optimization of a molding condition.

With the above configuration, the injection molding method according to embodiment 2 can be implemented.

[Feature Quantity Extracted from Sensor Value]

In embodiment 2, the input is a value of the molding condition and the output is a feature quantity extracted from a measured value of the sensor 212 in the mold.

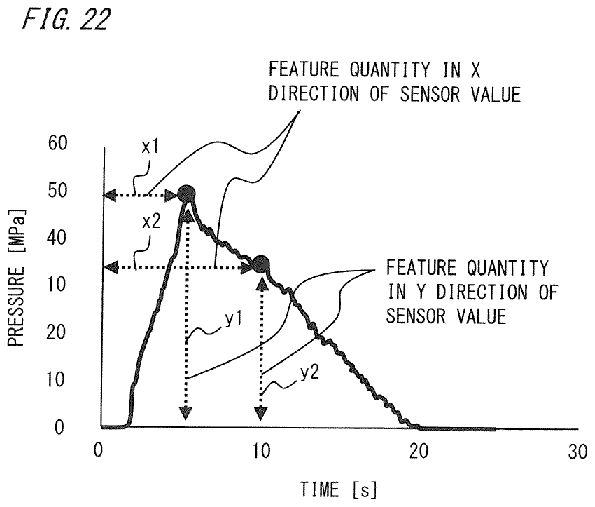

In this example, there are three feature quantities to be extracted from a sensor value in the mold and used as the output. The first and second feature quantities extracted from the sensor value are a feature quantity in the X direction and a feature quantity in the Y direction of the sensor value (specifically, the maximum value of the sensor value or a time until reaching the maximum value, a sensor value at the time when filling is completed or a time until reaching that value, and the like), as shown in FIG. 22.

In FIG. 22, as an example, the sensor value is a pressure sensor value, the feature quantity in the X direction of the sensor value is a time until reaching the maximum injection pressure value, and the feature quantity in the Y direction of the sensor value is the maximum injection pressure value. As the first and second feature quantities, any combination of the X direction and the Y direction of the sensor value may be adopted. As shown in FIG. 22, there may be two feature quantities (x1, x2) in the X direction or there may be two feature quantities (y1, y2) in the Y direction.

The third feature quantity extracted from the sensor value is a similarity of the sensor value when the molding condition has been changed, with respect to the reference sensor value.

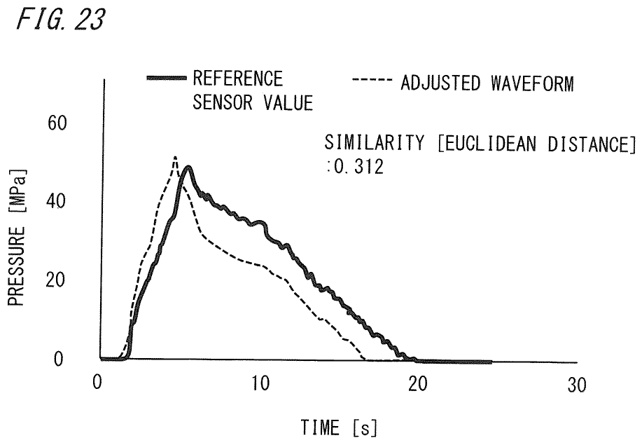

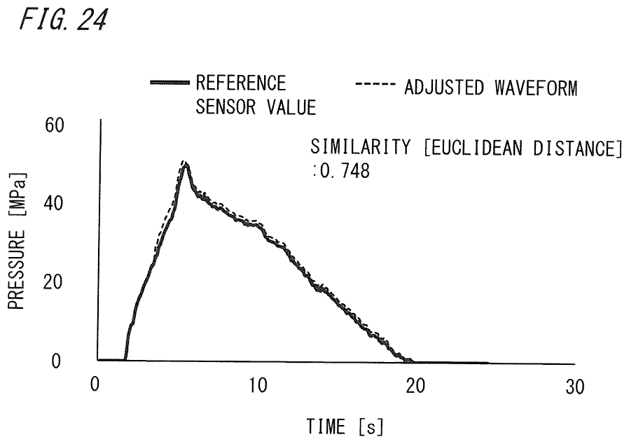

In embodiment 2, a case of using a Euclidean distance as the similarity will be shown as an example. The Euclidean distance is the shortest distance between two points in any dimension. As a specific calculation method, where the reference sensor value is represented by Formula (7) and the sensor value when the molding condition is changed is represented by Formula (8), a Euclidean distance d between the sensor values is calculated by Formula (9). As examples of the Euclidean distance obtained through calculation, FIG. 23 shows a case where the similarity is low and FIG. 24 shows a case where the similarity is high. In FIG. 23 and FIG. 24, a solid line indicates the waveform of the reference sensor value, and a dotted line indicates the waveform of the sensor value when the molding condition is changed.

As the similarity between the sensor values, a Manhattan distance, a cosine similarity, or a time integral value of the sensor value may be used, instead of the Euclidean distance.

$$\begin{matrix}[ Mathematical 7 ] & \\ {V}_{1} = ( {a}_{1} , {a}_{2} , … , {a}_{n} ) & ( 7 )\end{matrix}$$

$$\begin{matrix}[ Mathematical 8 ] & \\ {V}_{2} = ( {b}_{1} , {b}_{2} , … , {b}_{n} ) & ( 8 )\end{matrix}$$

$$\begin{matrix}[ Mathematical 9 ] & \\ d = \sqrt{{( {a}_{1} - {b}_{1} )}^{2} + {( {a}_{2} - {b}_{2} )}^{2} + … + {( {a}_{n} - {b}_{n} )}^{2}} = \sqrt{\sum {( {a}_{n} - {b}_{n} )}^{2}} & ( 9 )\end{matrix}$$

### [Parameter Search Method by Bayesian Optimization]

In embodiment 2, as in embodiment 1, in order to determine input parameters (molding condition) to be verified next, an acquisition function for performing evaluation for a combination of input parameter candidates is used. For the acquisition function, for example, probability of improvement (PI) or expected improvement (EI) may be used. Alternatively, upper confidence bound (UCB) or mutual information (MI) may be used.

In embodiment 2, as an example, an acquisition function called expected improvement (EI) for calculating an expected value for how much improvement will be made from an objective variable minimum (or maximum) value is used in association with three objective variables which are the feature quantities extracted from the sensor value described above, thereby matching with the reference sensor value. As a specific method therefor, a case where the acquisition function EI (expected improvement) is a minimization algorithm (Formula (5) and Formula (6) described above) will be described.

In order to match with the reference sensor value, it is necessary to combine different optimization methods for the three feature quantities of the sensor value described above which are objective variables. For the feature quantities in the X direction and the Y direction of the sensor value, ranges of ±3% from the feature quantities in the X direction and the Y direction of the reference sensor value are set as an optimization goal, and optimization is performed so as to fall within the above ranges. In order to cause the feature quantities in the X direction and the Y direction of the sensor value which are objective variables to fall within the optimization goal ranges using the minimization algorithm, the prediction mean μ outputted from the Gaussian process regression model described above is applied to Formula (10), to calculate a value μ′, and using the value μ′, optimization for falling within the goal range can be achieved. In Formula (10), RLupper denotes a value at +3% in the X direction and the Y direction of the reference sensor value, and RLlower denotes a value at −3% in the X direction and the Y direction of the reference sensor value. The percentages at the upper and lower limits with respect to the reference sensor value may be arbitrarily set in a range of ±10%.

$$\begin{matrix}[ Mathematical 10 ] & \\ {μ}^{′} = {( \frac{{RL}_{upper} - {RL}_{lower}}{2} - μ )}^{2} & ( 10 )\end{matrix}$$

For the similarity to the reference sensor value, optimization is performed so as to maximize the similarity. In order to perform processing of maximizing the similarity which is an objective variable using the minimization algorithm described above, the prediction mean μ outputted from the Gaussian process regression model described above is multiplied by −1 to invert the sign thereof, and using the resultant value, maximization of the objective variable can be performed.

In the present embodiment 2, the above-described processing is performed for the three objective variables, and then evaluation values (EI values) based on expected improvement (EI) described in embodiment 1 are synthesized to unify an acquisition function. As a method for unifying an evaluation value, a method of taking a weighted linear sum is used. Alternatively, a method of simply taking a sum or a product may be used.

In this example, the case where the sensor value is a pressure sensor value is described. However, as the sensor value, a temperature sensor value, an acoustic emission (AE) sensor value, a strain value of the mold measured by a strain gauge, or the like may be used to perform the same processing as described above.

In this example, regarding the sensor value, the feature quantity in the X direction and the feature quantity in the Y direction of a two-dimensional coordinate system are adopted. However, regarding the sensor value, a feature quantity in an X direction, a feature quantity in a Y direction, and a feature quantity in a Z direction of a three-dimensional coordinate system may be adopted, or a feature quantity in an x1 direction, a feature quantity in an x2 direction, . . . , and a feature quantity in an xN direction of the N-dimensional coordinate system (N is an integer not less than 2) may be adopted, to perform the same processing as described above.

### [Adjustment Method for Molding Condition]

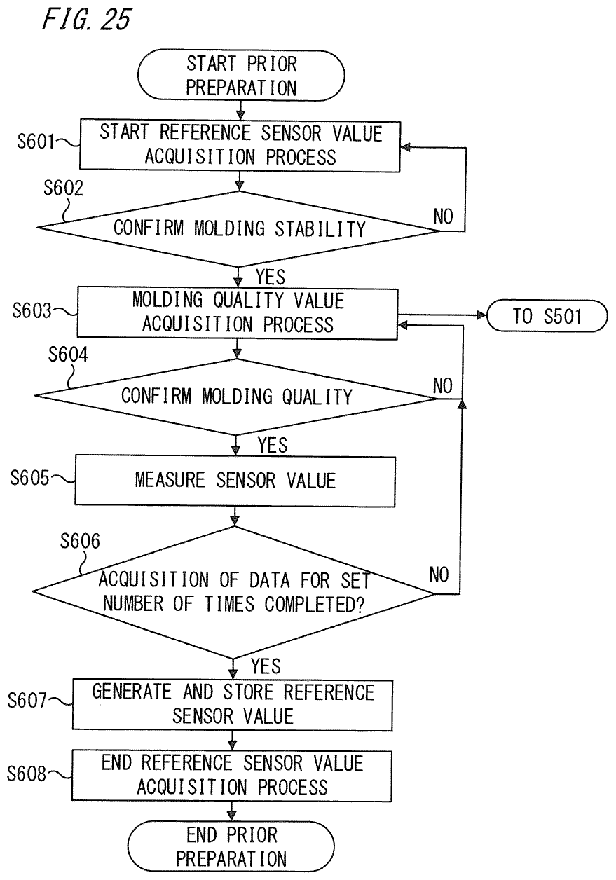

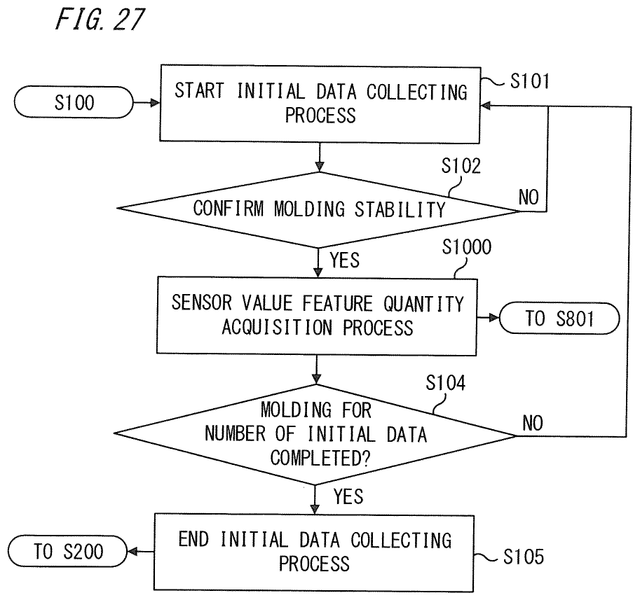

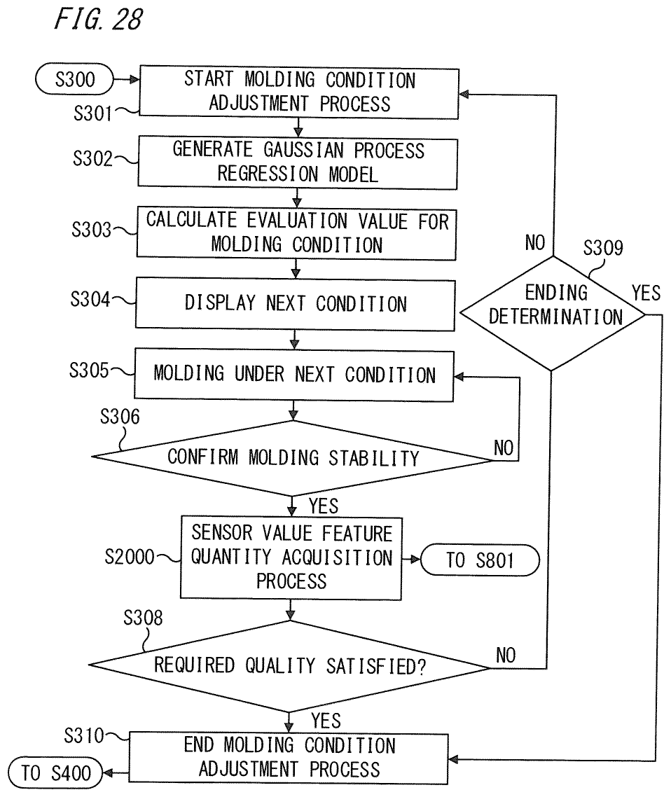

FIG. 25 to FIG. 28 are flowcharts showing an example of a sequential processing procedure for adjustment of the molding condition in the injection molding method of embodiment 2. Hereinafter, description will be given specifically, using a case of returning to a proper-product state when a defect has occurred in a molding product due to disturbance such as temperature change or lot change of the resin material, as an example. In the drawings, “S” denotes steps.

FIG. 25 is a flowchart showing an example of a sequential processing procedure for performing prior preparation for molding condition adjustment in the injection molding method according to embodiment 2.

First, before performing adjustment of the molding condition to return to a proper-product state, a reference sensor value acquisition process is started as prior preparation in accordance with the flowchart in FIG. 25 (step S601).

Then, confirmation for molding stability is performed first (step S602). As a specific confirmation method for molding stability, in the present embodiment 2, a fact that change in the value of the temperature sensor falls within a range of ±1° C. in three consecutive times of molding is a condition that molding stability is confirmed.

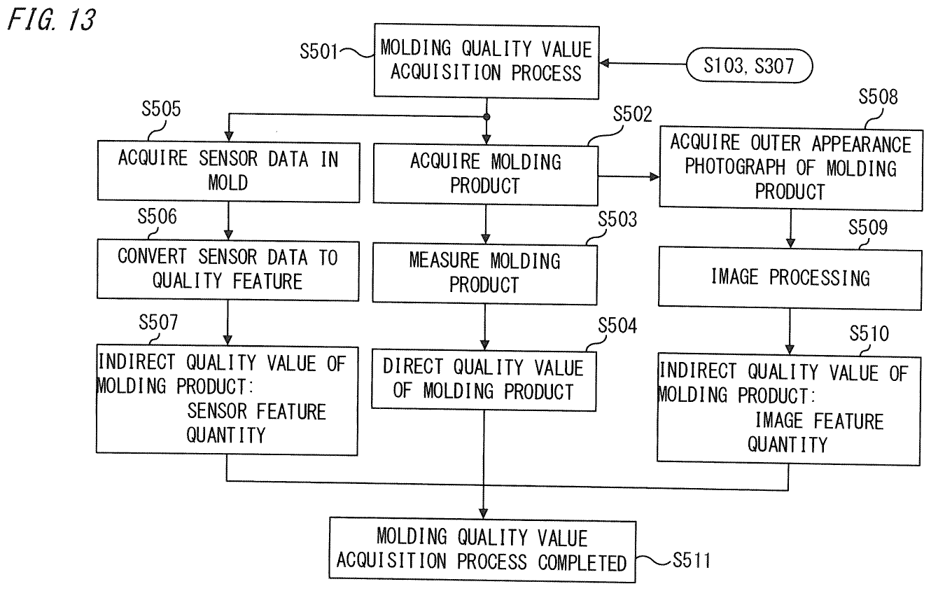

After molding stability has been confirmed, the molding quality value acquisition process (see FIG. 13) described in embodiment 1 is performed and it is confirmed that the molding quality value satisfies the required quality (step S603, step S604, and step S501 to step S511).

If a state in which the molding quality value does not satisfy the required quality continues, a molding condition that can produce a proper molding product is derived through the method of embodiment 1. Thereafter, the value of the sensor 212 (in this example, pressure sensor) when the required quality is satisfied is sent through the measurement amplifier 220 and the display input unit 130, to be stored into the storage unit 140 (step S605). In this case, sensor values are stored for a predetermined number of times set in advance (step S606). In this example, repetitive molding is performed 30 times as the predetermined number of times which is the number of times for storing sensor values, but the predetermined number of times may be arbitrarily set.

After acquisition of the sensor values is completed, a reference sensor value is generated utilizing the stored sensor values (step S607). As a specific method for generating the reference sensor value, for example, preprocessing such as removal or replacement for a missing value or noise is performed and then a mean value, a median value, or a weighted mean value of the sensor values is calculated. In this example, a mean value is used. At this time, from the generated reference sensor value, a feature quantity in the X direction (in this example, a time until reaching the maximum injection pressure value) and a feature quantity in the Y direction (in this example, the maximum injection pressure value) of the sensor value shown in FIG. 22 described above are acquired and then stored into the storage unit 140. After the reference sensor value is generated and stored, the reference sensor value acquisition process is ended (step S608). The above prior preparation may be performed not only at the time of deriving a molding condition for a mold but also during mass production of molding products.

After the reference sensor value for the molding product as a target is generated, molding condition adjustment for returning to a proper-product state is performed next.

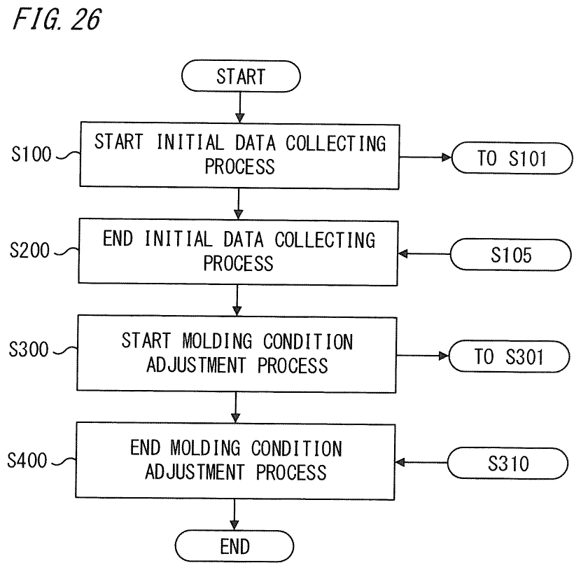

That is, in accordance with the flowchart in FIG. 26 to FIG. 28, the initial data collecting process is started (step S100 and step S101). For this purpose, first, the molding condition derivation device 100A is started, and setting for the molding-condition setting width information 141, the molding-condition item influence degrees 142, and the molding product information 143 described in embodiment 1 is performed. Then, the molding condition derivation program stored in the storage unit 140 is started.

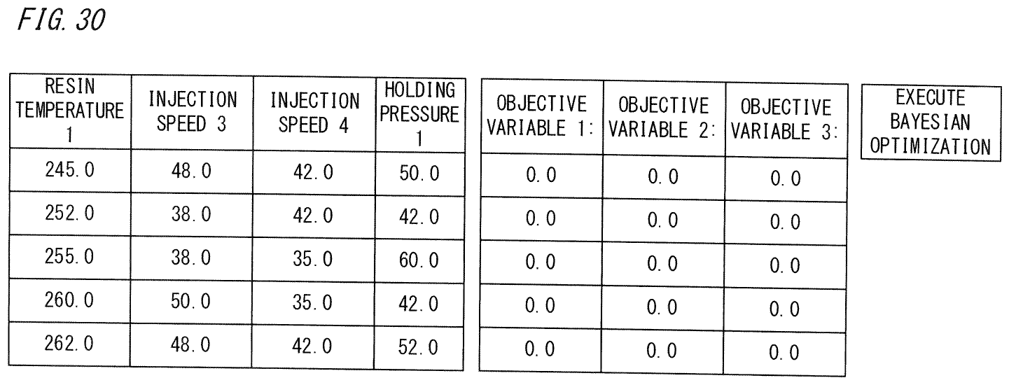

FIG. 30 shows a start screen of the molding condition derivation program in a case where there are four input parameters (resin temperature at first stage, injection speed at third stage, injection speed at fourth stage, and holding pressure at first stage) and three objective variables (objective variable 1: the feature quantity in the X direction of the sensor value, objective variable 2: the feature quantity in the Y direction of the sensor value, objective variable 3: the similarity to the sensor value of the reference waveform).

When started, the molding condition derivation program stored in the storage unit 140 selects items of the molding condition serving as input parameters that greatly influence change in the sensor value, from the molding-condition item influence degrees 142, and creates an initial molding condition table as shown in FIG. 30 so as to fall within the ranges in the molding-condition setting width information 141. Then, the content thereof is displayed on the display input unit 130.

FIG. 30 shows a case of such a setting that combinations of molding conditions are randomly outputted, but it is also possible to output a two-level orthogonal array with molding conditions as control factors. Alternatively, it is also possible that a scalar value of [Matrix of arbitrary number of molding conditions selected randomly]×[Transposed matrix of selected molding conditions] is defined as an optimization reference and an initial condition is selected so as to maximize the optimization reference.

The molding worker performs molding work in accordance with the initial molding condition table shown in FIG. 30, displayed on the display input unit 130 of the molding condition derivation device 100A. At this time, the molding condition may be manually inputted directly by the molding worker, or may be automatically inputted through the communication unit 110 if the injection molding machine 200 is connected via a network. The molding work is sequentially performed from the first row of the initial molding condition table in FIG. 30, to confirm molding stability (step S102).

In injection molding, after molding is started with a set molding condition or a molding condition changed subsequently, increase or decrease in the mold temperature gradually arises as the number of times of molding increases. Thereafter, while molding is performed a certain number of times, temperature change gradually decreases, so that it becomes possible to perform molding in the same mold temperature state. This state is used as a criterion for determining that the molding is stabilized.

As a specific confirmation method, in this example, as in embodiment 1, a fact that change in the value of the temperature sensor falls within a range of ±1° C. in three consecutive times of molding is a condition that molding stability is confirmed.

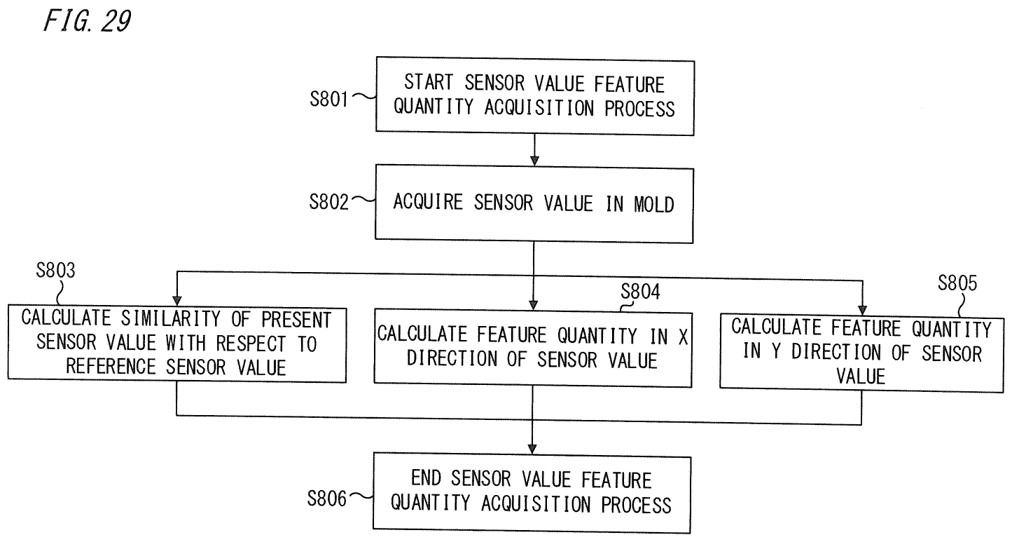

Next, after molding stability has been confirmed, feature quantities of the sensor value are acquired on the obtained molding product 211 in accordance with the flowchart in FIG. 29 (step S1000 and step S801). Time-series data of a pressure acquired by the sensor 212 and the measurement amplifier 220 during molding are transmitted to the molding condition derivation device 100A (step S802). The transmitted time-series data are sent to the sensor value feature quantity processing unit 125. The sensor value feature quantity processing unit 125 calculates the three feature quantities of the sensor value described above, i.e., the similarity of the present sensor value with respect to the reference sensor value (step S803), the feature quantity in the X direction of the sensor value (step S804), and the feature quantity in the Y direction of the sensor value (step S805). When acquisition of necessary values has been completed, the sensor value feature quantity acquisition process is ended (step S806).

Next, the steps for performing molding under each molding condition of the initial molding condition table by driving the injection molding machine 200 and then acquiring feature quantities of a sensor value as objective variables, are repeated for a number of times corresponding to the number of initial data shown in the initial molding condition table (step S104).

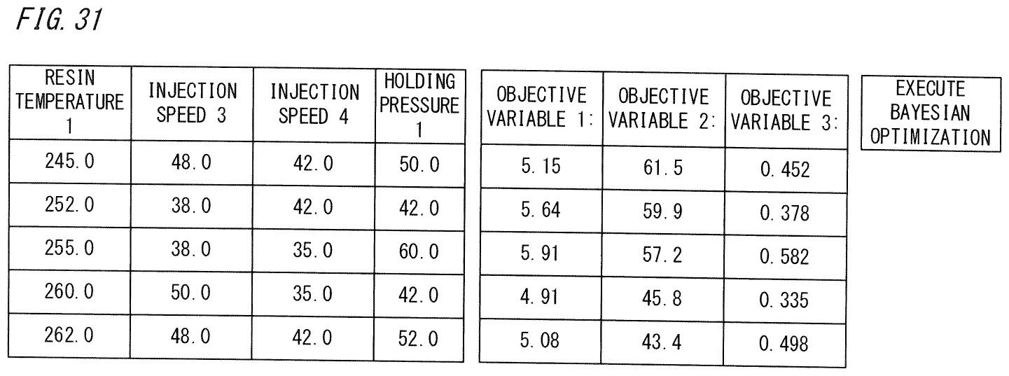

FIG. 31 illustrates an example of a screen of the molding condition derivation program in which the feature quantities of sensor values have been inputted, when molding for the number of initial data has been completed.

As shown in FIG. 31, when molding for the number of initial data has been completed and the initial data collecting process is ended (step S105 and step S200), the molding-condition adjustment unit 122A starts the molding condition adjustment process (step S300).

When the molding condition adjustment process is started (step S300 and step S301), repetitive molding based on the Bayesian optimization method described above is performed to achieve molding condition adjustment. For this purpose, first, a Gaussian process regression model is generated using the input parameters (values of molding conditions) and the objective variables (feature quantities of sensor values) collected in the initial data collecting process (step S302). That is, a prediction model (prediction function) is generated using the input parameters (values of molding conditions) and the objective variables (feature quantities of sensor values). A combination of molding condition values with which molding has not been performed yet is inputted to the Gaussian process regression model generated as described above, to obtain a prediction mean value and a prediction standard deviation. Then, numerical processing for applying the above-described minimization algorithm to the prediction mean value is performed, and using an acquisition function EI (expected improvement), an evaluation value for the molding condition inputted to the Gaussian process regression model is calculated (step S303).

Here, inputted combinations of molding condition values with which molding has not been performed yet are all combinations based on arithmetic progressions created for the set input parameters within the upper-lower-limit ranges of the molding-condition setting width information 141. The molding condition that yields the highest evaluation value is displayed as a molding condition to be performed next, on the graphical user interface (GUI) of the display input unit 130 (step S304).

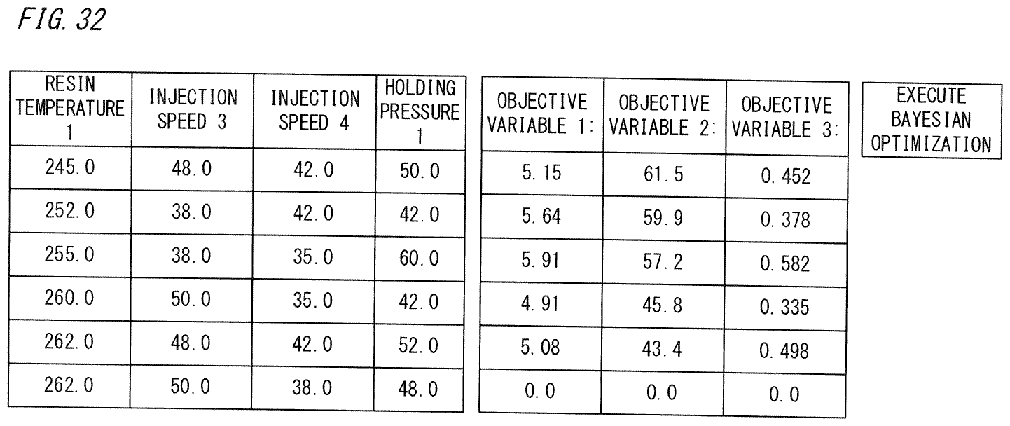

FIG. 32 illustrates an example of a screen of the molding condition derivation program on which the molding condition to be performed next is displayed.

In FIG. 32, the molding condition displayed at the last row is the molding condition to be performed next.

The processing of displaying the next molding condition as described above can be executed by clicking an “EXECUTE Bayesian OPTIMIZATION” button on the screen of the molding condition derivation program shown in FIG. 30 to FIG. 32.

Thereafter, as in the initial data collecting process, the injection molding machine 200 is driven to perform molding under the displayed molding condition (step S305). Further, as in the initial data collecting process, confirmation for molding stability (step S306) and acquisition of feature quantities of a sensor value (step S2000 and step S801) are performed. Then, if the acquired feature quantities of the sensor value satisfy the requirement (step S308), the molding condition adjustment process is ended (step S310 and step S400). In this example, it is determined that the requirement is satisfied when the Euclidean distance adopted as the similarity to the reference sensor value is not less than 0.7. On the other hand, if the requirement is not satisfied, an ending determination (step S309) is performed.

For the ending determination (step S309), in this example, setting is made so as to perform repetitive molding ten times as a designated number of times, but the number of times may be set arbitrarily. If the ending determination does not indicate end, the molding condition adjustment process is returned to start again (step S301), thus repeating the sequential flow. On the other hand, if the ending determination indicates end, the molding condition adjustment process is ended (step S310 and step S400).

As described above, in the present embodiment 2, a molding condition that satisfies a required quality of a molding product is derived by the Bayesian optimization method utilizing a regression model that can obtain a posterior distribution of an output with respect to an input, in particular, a Gaussian process regression model, whereby it is possible to construct a prediction function for adjusting a molding condition, even with a smaller number of data. Thus, it is possible to easily derive a proper molding condition for returning to a proper-product state when a defect has occurred in a molding product due to disturbance such as temperature change or lot change of the resin material, without depending on the skill level of a molding worker.

That is, the injection molding method according to embodiment 2 includes the following steps, and the computer-readable storage medium having stored therein a computer program according to embodiment 2 is configured to, when the computer program is executed by a processor, execute the following steps.

That is, the steps to be executed are the steps of:
constructing a prediction model on the basis of an input parameter including a molding condition for a molding product, and objective variable values including a feature quantity of a sensor value of a sensor provided to an injection molding machine with respect to the input parameter and a similarity of the sensor value when the molding condition for the molding product is changed with respect to a reference sensor value which is the sensor value when the molding product satisfies a required quality;
inferring predictive distributions of the objective variable values with respect to the input parameter, using the prediction model; and
deriving such a molding condition that satisfies the required quality of the molding product, by a Bayesian optimization method utilizing a regression model for obtaining the input parameter with which evaluation of the objective variable values indicates becoming closer to a feature quantity of the reference sensor value as compared to a feature quantity of an initial sensor value, on the basis of the predictive distributions.

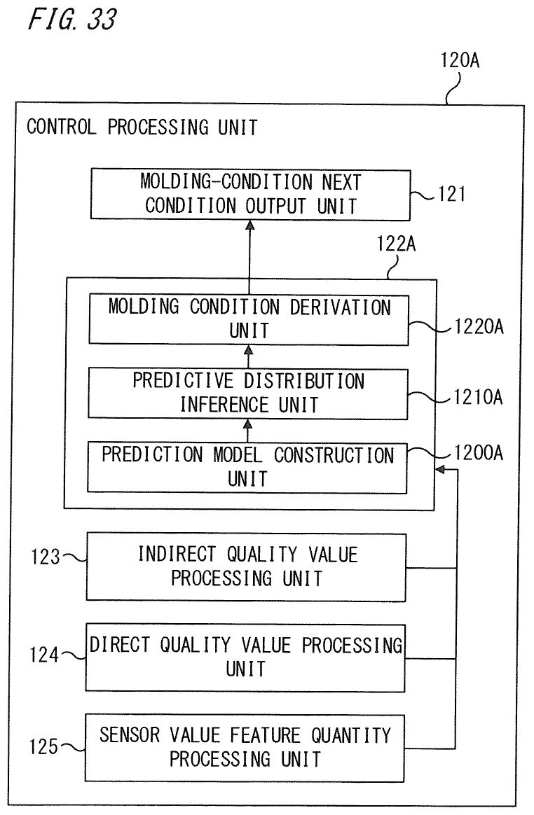

The injection molding method and the computer-readable storage medium described above are executed by, as shown in FIG. 33, the molding-condition adjustment unit 122A in the control processing unit 120A of the molding condition derivation device 100A in FIG. 21.

Then, the molding-condition adjustment unit 122A shown in FIG. 33 includes: a prediction model construction unit 1200A which constructs a prediction model on the basis of the input parameter including the molding condition for the molding product, and the objective variable values including the feature quantity of the sensor value of the sensor provided to the injection molding machine with respect to the input parameter and the similarity of the sensor value when the molding condition for the molding product is changed with respect to the reference sensor value which is the sensor value when the molding product satisfies the required quality; a predictive distribution inference unit 1210A which infers predictive distributions of the objective variable values with respect to the input parameter, using the prediction model; and a molding condition derivation unit 1220A which derives such a molding condition that satisfies the required quality of the molding product, by the Bayesian optimization method utilizing the regression model for obtaining the input parameter with which evaluation of the objective variable values indicates becoming closer to a feature quantity of the reference sensor value as compared to a feature quantity of an initial sensor value, on the basis of the predictive distributions.

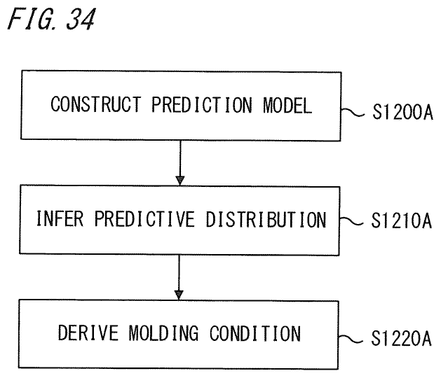

In addition, as shown in the flowchart in FIG. 34, the injection molding method according to embodiment 1 includes the following steps, and the computer-readable storage medium having stored therein a computer program according to embodiment 1 is configured to, when the computer program is executed by a processor, execute the following steps.

That is, as shown in FIG. 34, the steps to be executed are the steps of: constructing a prediction model on the basis of an input parameter including a molding condition for a molding product, and objective variable values including a feature quantity of a sensor value of a sensor provided to an injection molding machine with respect to the input parameter and a similarity of the sensor value when the molding condition for the molding product is changed with respect to a reference sensor value which is the sensor value when the molding product satisfies a required quality (step S1200A); inferring predictive distributions of the objective variable values with respect to the input parameter, using the prediction model (step S1210A); and deriving such a molding condition that satisfies the required quality of the molding product, by a Bayesian optimization method utilizing a regression model for obtaining the input parameter with which evaluation of the objective variable values indicates becoming closer to a feature quantity of the reference sensor value as compared to a feature quantity of an initial sensor value, on the basis of the predictive distributions (step S1220A).

Also in embodiment 2, as in embodiment 1, the control processing unit 120A is composed of, for example, as shown in the hardware configuration example in FIG. 17, the processor 1000 such as a central processing unit (CPU) or a graphics processing unit (GPU), and the storage device 1010 (storage unit 140), and is implemented by the processor 1000 executing the program stored in the storage device 1010 (storage unit 140).

Therefore, processing in the prediction model construction unit 1200A, the predictive distribution inference unit 1210A, and the molding condition derivation unit 1220A of the molding-condition adjustment unit 122A shown in FIG. 33 and processing in steps S1200A, S1210A, S1220A executed in the flowchart shown in FIG. 34, are implemented by the processor 1000 executing the program stored in the storage device 1010 (storage unit 140).

Although the disclosure is described above in terms of an exemplary embodiment, it should be understood that the various features, aspects, and functionality described in the embodiment are not limited in their applicability to the particular embodiment with which they are described, but instead can be applied alone or in various combinations to the embodiment of the disclosure.

It is therefore understood that numerous modifications which have not been exemplified can be devised without departing from the scope of the present disclosure. For example, at least one of the constituent components may be modified, added, or eliminated.

### DESCRIPTION OF THE REFERENCE CHARACTERS

100, 100A molding condition derivation device
110 communication unit
120, 120A control processing unit
121 molding-condition next condition output unit
122, 122A molding-condition adjustment unit
123 indirect quality value processing unit
124 direct quality value processing unit
125 sensor value feature quantity processing unit
130 display input unit
140 storage unit
141 molding-condition setting width information
142 molding-condition item influence degrees
143 molding product information
200 injection molding machine
210 mold
211 molding product (during molding)
212 sensor
220 measurement amplifier
300 take-out robot
400 transportation conveyor
500 molding product (after molding)
600 shape measurement device
700 camera
1200, 1200A prediction model construction unit
1210, 1210A predictive distribution inference unit
1220, 1220A molding condition derivation unit

1. An injection molding method comprising the steps of:
constructing a prediction model on the basis of an input parameter including a molding condition for a molding product and an objective variable value, which is at least one of a direct quality value obtained by directly measuring the molding product and an indirect quality value including a feature quantity converted from data of a sensor provided in a mold of an injection molding machine or an outer appearance image of the molding product, including a quality value that quantifies a required quality of the molding product with respect to the input parameter;
inferring a predictive distribution of the objective variable value with respect to the input parameter, using the prediction model; and
deriving such a molding condition that yields the highest evaluation so that a quality value of the molding product becomes a desired value, by a Bayesian optimization method utilizing a regression model for obtaining the input parameter that yields a quality value highest in evaluation of the objective variable value as compared to an initial quality value, on the basis of the predictive distribution,
wherein
the injection molding method derives such a molding condition that satisfies the required quality, by using an optimization method that repeats evaluation of the objective variable value under the derived molding conditions and derivation of the molding condition that yields the highest evaluation so that the quality value becomes the desired value.

2. (canceled)

3. The injection molding method according to claim 1, wherein
the regression model is a Gaussian process regression model.

4. A molding condition derivation device for performing adjustment of a molding condition for a molding product on the basis of the injection molding method according to claim 1, the molding condition derivation device comprising:
a storage circuitry in which information about the molding condition and a required quality of the molding product is stored in advance; and
a control processing circuitry, wherein
the control processing circuitry includes
a direct quality value processing circuitry which obtains a direct quality value by directly measuring the molding product,
an indirect quality value processing circuitry which obtains an indirect quality value including a feature quantity converted from data of a sensor provided in a mold of an injection molding machine or an outer appearance image of the molding product, and
a molding-condition adjustment circuitry which takes in, as a quality value, at least one of the direct quality value from the direct quality value processing circuitry or the indirect quality value from the indirect quality value processing circuitry, and derives such a molding condition that satisfies an optimum required quality of the molding product, by a Bayesian optimization method utilizing a regression model, using the quality value that has been taken in and the information about the molding condition and the required quality stored in the storage circuitry.

5. The molding condition derivation device according to claim 4, wherein
the molding-condition adjustment circuitry includes
a prediction model construction circuitry which constructs a prediction model on the basis of the input parameter including the molding condition for the molding product and the objective variable value including the quality value that quantifies the required quality of the molding product with respect to the input parameter,
a predictive distribution inference circuitry which infers a predictive distribution of the objective variable value with respect to the input parameter, using the prediction model, and
a molding condition derivation circuitry which derives such a molding condition that satisfies the required quality of the molding product, by the Bayesian optimization method utilizing the regression model for obtaining the input parameter that yields a quality value highest in evaluation of the objective variable value as compared to an initial quality value, on the basis of the predictive distribution.

6. A computer-readable storage medium having stored therein a computer program configured to, when the computer program is executed by a processor, execute the steps of:
constructing a prediction model on the basis of an input parameter including a molding condition for a molding product and an objective variable value, which is at least one of a direct quality value obtained by directly measuring the molding product and an indirect quality value including a feature quantity converted from data of a sensor provided in a mold of an injection molding machine or an outer appearance image of the molding product, including a quality value that quantifies a required quality of the molding product with respect to the input parameter;
inferring a predictive distribution of the objective variable value with respect to the input parameter, using the prediction model; and
deriving such a molding condition that yields the highest evaluation so that a quality value of the molding product becomes a desired value, by a Bayesian optimization method utilizing a regression model for obtaining the input parameter that yields a quality value highest in evaluation of the objective variable value as compared to an initial quality value, on the basis of the predictive distribution,
wherein
the computer-readable storage medium derives such a molding condition that satisfies the required quality, by using an optimization method that repeats evaluation of the objective variable value under the derived molding conditions and derivation of the molding condition that yields the highest evaluation so that the quality value becomes the desired value.

7. (canceled)

8. The computer-readable storage medium according to claim 6, wherein
the regression model is a Gaussian process regression model.

9. An injection molding method comprising the steps of:
constructing a prediction model on the basis of an input parameter including a molding condition for a molding product, and objective variable values including a feature quantity of a sensor value of a sensor provided to an injection molding machine with respect to the input parameter and a similarity of the sensor value when the molding condition for the molding product is changed with respect to a reference sensor value which is the sensor value when the molding product satisfies a required quality;
inferring predictive distributions of the objective variable values with respect to the input parameter, using the prediction model; and
deriving such a molding condition that satisfies the required quality of the molding product, by a Bayesian optimization method utilizing a regression model for obtaining the input parameter with which evaluation of the objective variable values indicates becoming closer to a feature quantity of the reference sensor value as compared to a feature quantity of an initial sensor value, on the basis of the predictive distributions.

10. The injection molding method according to claim 9, wherein
feature quantities of the sensor value in an x1 direction, an x2 direction, . . . , and an xN direction of an N-dimensional coordinate system (N is an integer not less than 2) which are obtained from the sensor value, and the similarity of the sensor value with respect to the reference sensor value, are used for deriving the molding condition.

11. The injection molding method according to claim 9, wherein
the regression model is a Gaussian process regression model.

12. A molding condition derivation device for performing adjustment of a molding condition for a molding product on the basis of the injection molding method according to claim 9, the molding condition derivation device comprising:
a storage circuitry in which information about the molding condition and a required quality of the molding product is stored in advance; and
a control processing circuitry, wherein
the control processing circuitry includes
a sensor value feature quantity processing circuitry which calculates the feature quantity of the sensor value obtained from the sensor value, and the similarity of the sensor value with respect to the reference sensor value, and
a molding-condition adjustment circuitry which takes in the feature quantity of the sensor value and the similarity of the sensor value with respect to the reference sensor value from the sensor value feature quantity processing circuitry, and derives such a molding condition that satisfies an optimum required quality of the molding product, by a Bayesian optimization method utilizing a regression model, using the feature quantity of the sensor value and the similarity of the sensor value with respect to the reference sensor value which have been taken in and the information about the molding condition and the required quality stored in the storage circuitry.

13. The molding condition derivation device according to claim 12, wherein
the molding-condition adjustment circuitry includes
a prediction model construction circuitry which constructs a prediction model on the basis of the input parameter including the molding condition for the molding product, and the objective variable values including the feature quantity of the sensor value of the sensor provided to the injection molding machine with respect to the input parameter and the similarity of the sensor value when the molding condition for the molding product is changed with respect to the reference sensor value which is the sensor value when the molding product satisfies the required quality,
a predictive distribution inference circuitry which infers predictive distributions of the objective variable values with respect to the input parameter, using the prediction model, and
a molding condition derivation circuitry which derives such a molding condition that satisfies the required quality of the molding product, by the Bayesian optimization method utilizing the regression model for obtaining the input parameter with which evaluation of the objective variable values indicates becoming closer to a feature quantity of the reference sensor value as compared to a feature quantity of an initial sensor value, on the basis of the predictive distributions.

14. (canceled)

15. (canceled)

16. (canceled)

17. The molding condition derivation device according to claim 4, wherein
the regression model is a Gaussian process regression model.

18. The molding condition derivation device according to claim 17, wherein
the molding-condition adjustment circuitry includes
a prediction model construction circuitry which constructs a prediction model on the basis of the input parameter including the molding condition for the molding product and the objective variable value including the quality value that quantifies the required quality of the molding product with respect to the input parameter,
a predictive distribution inference circuitry which infers a predictive distribution of the objective variable value with respect to the input parameter, using the prediction model, and
a molding condition derivation circuitry which derives such a molding condition that satisfies the required quality of the molding product, by the Bayesian optimization method utilizing the regression model for obtaining the input parameter that yields a quality value highest in evaluation of the objective variable value as compared to an initial quality value, on the basis of the predictive distribution.

19. The injection molding method according to claim 10, wherein
the regression model is a Gaussian process regression model.

20. The molding condition derivation device according to claim 12, wherein
feature quantities of the sensor value in an x1 direction, an x2 direction, . . . , and an xN direction of an N-dimensional coordinate system (N is an integer not less than 2) which are obtained from the sensor value, and the similarity of the sensor value with respect to the reference sensor value, are used for deriving the molding condition.

21. The molding condition derivation device according to claim 12, wherein
the regression model is a Gaussian process regression model.
